(19) United States
(12) Patent Application Publication
(10) Pub. No.: US 2014/0358943 A1
(43) Pub. Date: Dec. 4, 2014

(54) Method and System for Determining Suitability and Desirability of a Prospective Residence for a User

(71) Applicant: n35t, Inc., San Francisco, CA (US)

(72) Inventors: Leonard G. Raymond, San Francisco, CA (US); Jeremy J. Bornstein, San Francisco, CA (US); Christopher Foley, San Francisco, CA (US); Frederick Felman, San Francisco, CA (US); David Llopis, San Francisco, CA (US)

(73) Assignee: n35t, Inc., San Francisco, CA (US)

(21) Appl. No.: 14/285,135

(22) Filed: May 22, 2014

Related U.S. Application Data
(60) Provisional application No. 61/828,082, filed on May 28, 2013.
(60) Provisional application No. 61/828,089, filed on May 28, 2013.
(60) Provisional application No. 61/828,091, filed on May 28, 2013.
(60) Provisional application No. 61/828,093, filed on May 28, 2013.
(60) Provisional application No. 61/944,689, filed on Feb. 26, 2014.

(51) Int. Cl. G06F 17/30

(52) U.S. Cl. CPC G06F 17/3053
USPC 707/748

(57) ABSTRACT

Novel tools and techniques for determining suitability and/or desirability of a prospective residence for a user. In some embodiments, a computer might receive a list of real estate listings, each pertaining to, and including a plurality of attributes about, an available home. The computer might collect information about factors relating to a user, generate a user profile based at least in part on the factors, and infer a prioritized list of real estate listing characteristics to satisfy the user based on a prioritized list of user criteria. The computer might subsequently generate and prioritize a list of potential homes from the list of real estate listings, based on comparisons, and at least in part on matches, between the prioritized list of real estate listing characteristics and attributes of at least some potential homes in the listings. The computer might subsequently display the prioritized list of potential homes to the user.

### CROSS-REFERENCES TO RELATED APPLICATIONS

This application claims priority to the following commonly assigned applications/patents:

Provisional U.S. Patent Application No. 61/828,082 filed on May 28, 2013 by Raymond et al. and titled “Determining the Suitability of a Prospective Residence Using a Plurality of Factors” (attorney docket no. 0600.01-PR), which is hereby incorporated by reference, as if set forth in full in this document, for all purposes.

Provisional U.S. Patent Application No. 61/828,089 filed on May 28, 2013 by Raymond et al. and titled “Reducing the Amount of User Input Required to Produce an Effective User Profile” (attorney docket no. 0600.02-PR), which is hereby incorporated by reference, as if set forth in full in this document, for all purposes.

Provisional U.S. Patent Application No. 61/828,091 filed on May 28, 2013 by Bornstein et al. and titled “Using Locations of Associated Parties to Determine Desirability of a Prospective Residence for a User” (attorney docket no. 0600.03-PR), which is hereby incorporated by reference, as if set forth in full in this document, for all purposes.

Provisional U.S. Patent Application No. 61/828,093 filed on May 28, 2013 by Bornstein et al. and titled “Personalizing and Facilitating the Search Process for Residential Real Estate and Providing Predictive Models of Real Estate Preferences” (attorney docket no. 0600.04-PR), which is hereby incorporated by reference, as if set forth in full in this document, for all purposes.

Provisional U.S. Patent Application No. 61/944,689 filed on Feb. 26, 2014 by Raymond et al. and titled “System and Method for Personalizing Housing-Preference Relevant Content” (attorney docket no. 0600.05-PR), which is hereby incorporated by reference, as if set forth in full in this document, for all purposes.

The respective disclosures of the applications listed above (collectively, the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for facilitating prospective residence searches for prospective homeseekers, and, more particularly, to methods, systems, and apparatuses for determining suitability and/or desirability of a prospective residence for a user.

### BACKGROUND

In looking for a prospective new home, whether for purchase or for rent/lease, homeseekers typically take into account a number of different attributes about the prospective properties and neighborhoods/areas, as well as a number of personal factors about the homeseeker. In some cases, the homeseeker might also consider location relative to work, family, friends, shopping, dining, etc., as well as opinions and/or factors relating to family, friends, coworkers, enemies, celebrities, etc. (collectively, “friends”).

Currently available home listings services and user interfaces, however, do not take into account (e.g., in customized user profiles) the number of different attributes about the prospective properties and neighborhoods/areas and the number of personal factors about the homeseeker, much less information related to friends of the homeseeker or information related to the homeseeker's social network.

User profiles for non-home-related purposes also typically do not take into account the variety of information about the user or about friends of the user (i.e., that take into account the user's social graph). As such, such user profiles are incapable of synthesizing appropriate, or fully-dimensioned, recommendations or user-customized settings for the user.

Hence, there is a need for more robust and scalable solutions for facilitating prospective residence searches for prospective homeseekers and for generating user profiles for home-related and/or non-home-related purposes.

### BRIEF SUMMARY

Various embodiments provide tools and techniques for determining the suitability of a prospective residence for a prospective home buyer or renter (“user” or “homeseeker”) using a plurality of endogenous and/or exogenous factors. Various embodiments provide tools and techniques for using the present and/or historical locations of associates (which can be any entities with a cognizable relationship to the user, such as friends, family, associates, enemies, etc.) as a means of determining the desirability of a prospective residence for a user. Various embodiments provide tools and techniques for personalizing and facilitating the search process for residential real estate and providing predictive models of real estate preferences.

Various embodiments provide tools and techniques for reducing the amount of user input required to produce an effective user preference profile. In an aspect, some embodiments provide this ability by probabilistically determining a subset of users' preference profiles likely to fit a given user. In another aspect, certain embodiments can reduce the need for elicitation of user responses to disambiguate among the subset of profiles, by using previously-acquired demographic, psychographic, and/or other key values exogenous to the profile. Various embodiments provide tools and techniques for leveraging diverse sets of needs of homeseekers in prospective housing. In an aspect, by using information provided by homeseekers and/or provided by third parties about these homeseekers, an understanding of those sets of needs can be developed and used to tailor content intended for homeseeker use in assessing properties for purchase and/or rental, and the tailored content can be synthesized within a generated needs profile for the homeseekers.

In some embodiments, a computer might receive a list of real estate listings, each pertaining to, and including a plurality of attributes about, an available home for purchase or rent/lease. The computer might collect information about a plurality of factors relating to a prospective homeseeker, generate a user profile based at least in part on the plurality of factors, and infer a prioritized list of real estate listing characteristics to satisfy the user based on a prioritized list of homeseeker criteria that is part of the user profile.

To generate the user profile, the computer might collect data about the user from a variety of sources, including, without limitation, the user himself or herself, social network servers and/or databases, data collection servers and/or databases that collect data about the user (knowingly or unbeknownst to the user), and/or the like. The data might be related to homes, related to non-home-related matters (e.g., information relating to a number of preferences of the user, including car preferences, travel preferences, smart phone preferences, etc.), or both. In some cases, the data might include home-related and non-home-related information about people associated or otherwise related to the user, who might include family/relatives, close friends, acquaintances, former/current classmates, former/current co-workers, enemies, frenemies, celebrities whom the user likes/follows, celebrities whom the user hates/avoids, and/or the like (collectively, “friends”). Such information about the user and his or her friends may also be used to generate other user preference profiles for the user that are non-home-related.

The computer might subsequently generate and prioritize a list of potential homes from the list of real estate listings, based on comparisons, and at least in part on matches, between the prioritized list of real estate listing characteristics and attributes of at least some potential homes in the listings. The computer might subsequently display the prioritized list of potential homes to the user.

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

In an aspect, a method might comprise receiving, with a computer and from a database, a list of real estate listings. Each listing might pertain to an available home and might comprise a plurality of attributes about the available home. The method might further comprise collecting, with the computer, information about a plurality of factors relating to a prospective homeseeker and generating, with the computer, a homeseeker profile for the prospective homeseeker, based at least in part on the plurality of factors. The homeseeker profile might comprise a prioritized list of homeseeker criteria. The method might also comprise inferring, with the computer and from the prioritized list of homeseeker criteria, a prioritized list of real estate listing characteristics to satisfy the homeseeker and generating, with the computer, a list of potential homes from the list of real estate listings, based on comparisons between the prioritized list of real estate listing characteristics and attributes of at least some of the real estate listings. The method might further comprise prioritizing, with the computer, the list of potential homes, based at least in part on matches between attributes of the potential homes and the prioritized list of real estate listing characteristics and displaying, for the prospective homeseeker, the prioritized list of potential homes. In some embodiments, matches need not be exact; rather, closeness of a match to a target value may be a factor. In some cases, the criteria and/or attributes may have different weights.

According to some embodiments, the list of real estate listings might be a list of properties available for lease, where the homeseeker is interested in leasing a home, while in other embodiments, the list of real estate listings might be a list of properties for sale, where the homeseeker is interested in purchasing a home. In some embodiments, generating the list of potential homes might comprise generating a composite score for each of the potential homes. The composite score might be a weighted score derived from a plurality of the homeseeker criteria. In some cases, the method might further comprise adjusting relative weights of one or more of the plurality of homeseeker criteria, using a learning algorithm, to enhance prospective homeseeker satisfaction with the displayed list of potential homes.

Merely by way of example, in various embodiments, the plurality of factors might comprise factors including, without limitation, a location of a likely frequent destination of the prospective homeseeker, a history of prior residences of the prospective homeseeker, information obtained from a social networking account of the potential homeseeker, information indicative of user preferences of the homeseeker across a multiplicity of dimensions comprising home-related dimensions and non-home-related dimensions, information about locations of a plurality of associates of the homeseeker, and/or the like. In some embodiments, the method might further comprise identifying, with the computer, the plurality of associates of the homeseeker. Identifying the plurality of associates of the homeseeker, in some instances, might comprise identifying individuals associated with the homeseeker on one or more social networks.

In some embodiments, the plurality of attributes of each available home might comprise attributes including, but not limited to, an estimated total monthly cost of the available home, an estimated total cost of ownership of the available home, and/or the like.

According to some embodiments, generating the homeseeker profile might comprise analyzing at least one of a psychographic relationship or a behavioral relationship between one or more of the plurality of factors and one or more of the homeseeker criteria. In some cases, generating the homeseeker profile might comprise generating the homeseeker profile using at least in part data from at least one of a demographic segment or a behavioral segment of a population group known to match at least some known characteristics of the homeseeker. In some instances, generating the homeseeker profile might comprise estimating demand for one or more features of available homes based on aggregate behavior of a plurality of homeseekers other than the prospective homeseeker. In some embodiments, the prospective homeseeker might have a relationship with each of the plurality of homeseekers other than the prospective homeseeker, while in some cases, there may be no relationship between the prospective homeseeker and one or more of the plurality of homeseekers other than the prospective homeseeker. According to an aspect, generating the homeseeker profile might comprise collecting information about a plurality of factors relating to each of a plurality of individuals within a single household. In some instances, collecting information about a plurality of factors might comprise collecting, from one or more of the plurality of individuals within the single household, self-reported personal data about one or more individuals of the plurality of individuals within the single household. In some cases, collecting information about a plurality of factors might comprise collecting, from one or more of business, social media sources, or other on-line sources, information indicative of personal preferences and demographic information about one or more individuals of the plurality of individuals within the single household, as a result of one or more of business activities, social media activities, or other on-line activities of the one or more individuals within the household.

Merely by way of example, in some aspects, the method might further comprise customizing a display of the list of potential homes, based at least in part on the prioritized list of homeseeker criteria. In some embodiments, customizing a display of the list of potential homes might comprise emphasizing features of each potential home that correspond to high-priority homeseeker criteria. In some cases, customizing a display of the list of potential homes might comprise one of de-emphasizing or eliminating features of each potential home that correspond to homeseeker criteria that are indicated as being one of unimportant or adverse to interests of the prospective homeseeker.

In another aspect, an apparatus might comprise a non-transitory computer readable medium having encoded thereon a set of instructions executable by one or more computers to perform one or more operations. The set of instructions might comprise instructions to receive, from a database, a list of real estate listings. Each listing might pertain to an available home and might comprise a plurality of attributes about the available home. The set of instructions might further comprise instructions to collect information about a plurality of factors relating to a prospective homeseeker and instructions to generate a homeseeker profile for the prospective homeseeker, based at least in part on the plurality of factors. The homeseeker profile might comprise a prioritized list of homeseeker criteria. The set of instructions might also comprise instructions to infer, from the prioritized list of homeseeker criteria, a prioritized list of real estate listing characteristics to satisfy the homeseeker and instructions to generate a list of potential homes from the list of real estate listings, based on comparisons between the prioritized list of real estate listing characteristics and attributes of at least some of the real estate listings. The set of instructions might further comprise instructions to prioritize a list of potential homes, based at least in part on matches between attributes of the potential homes and the prioritized list of real estate listing characteristics and instructions to display the prioritized list of potential homes. In some embodiments, matches need not be exact; rather, closeness of a match to a target value may be a factor. In some cases, the criteria and/or attributes may have different weights.

In yet another aspect, a computer system might comprise one or more processors and a computer readable medium in communication with the one or more processors. The computer readable medium might have encoded thereon a set of instructions executable by the computer system to perform one or more operations. The set of instructions might comprise instructions to receive, from a database, a list of real estate listings. Each listing might pertain to an available home and might comprise a plurality of attributes about the available home. The set of instructions might further comprise instructions to collect information about a plurality of factors relating to a prospective homeseeker and instructions to generate a homeseeker profile for the prospective homeseeker, based at least in part on the plurality of factors. The homeseeker profile might comprise a prioritized list of homeseeker criteria. The set of instructions might also comprise instructions to infer, from the prioritized list of homeseeker criteria, a prioritized list of real estate listing characteristics to satisfy the homeseeker and instructions to generate a list of potential homes from the list of real estate listings, based on comparisons between the prioritized list of real estate listing characteristics and attributes of at least some of the real estate listings. The set of instructions might further comprise instructions to prioritize a list of potential homes, based at least in part on matches between attributes of the potential homes and the prioritized list of real estate listing characteristics and instructions to display the prioritized list of potential homes. In some embodiments, matches need not be exact; rather, closeness of a match to a target value may be a factor. In some cases, the criteria and/or attributes may have different weights.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram illustrating a system for determining suitability and/or desirability of a prospective residence for a user, in accordance with various embodiments.

FIG. 2 is a general schematic flow diagram illustrating a method for determining suitability and/or desirability of a prospective residence for a user, in accordance with various embodiments.

FIG. 3 is a process flow diagram illustrating a method of determining the suitability of a prospective residence, in accordance with various embodiments.

FIG. 4 is a process flow diagram illustrating a method of determining the desirability of a prospective residence for a user, in accordance with various embodiments.

FIG. 5 is a process flow diagram illustrating a method of determining a user's preference profile, in accordance with various embodiments.

FIG. 6 is a process flow diagram illustrating a method of personalizing housing-preference-relevant content, in accordance with various embodiments.

FIG. 7 is a block diagram illustrating an exemplary computer architecture, in accordance with various embodiments.

FIG. 8 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Features Provided By Various Embodiments

Overview:

Various embodiments provide tools and techniques for determining the suitability of a prospective residence for a prospective home buyer or renter (herein referred to interchangeably as either “user” or “homeseeker”) using a plurality of endogenous and/or exogenous factors. Herein, “endogenous” factors of a prospective home might refer to properties or characteristics of the prospective home itself, including, but not limited to, size, lot size, layout, features, equipment, construction, materials, age, finishes, landscaping, levelness of ground, aesthetics, and/or the like. “Exogenous” factors of the prospective home might refer to properties or characteristics of the prospective home's surroundings, including, without limitation, crime rate of neighborhood, cleanliness of neighborhood, demographics of neighbors, quality of schools nearby and/or in the school district, distance to mass transit stop, distance to parks, shopping and amenities within walking distance, and/or the like.

Various embodiments provide tools and techniques for using the present and/or historical locations of associates (which can be any entities with a cognizable relationship to the user, such as friends, family, associates, enemies, etc.) as a means of determining the desirability of a prospective residence for a user.

Various embodiments provide tools and techniques for personalizing and facilitating the search process for residential real estate and providing predictive models of real estate preferences.

These embodiments are collectively referred to herein as “Homeseeker Search Tools and Techniques.”

Various embodiments provide tools and techniques for reducing the amount of user input required to produce an effective user preference profile. In an aspect, some embodiments provide this ability by probabilistically determining a subset of users' preference profiles likely to fit a given user. In another aspect, certain embodiments can reduce the need for elicitation of user responses to disambiguate among the subset of profiles, by using previously-acquired demographic, psychographic, and/or other key values exogenous to the profile.

Various embodiments provide tools and techniques for leveraging diverse sets of needs of homeseekers in prospective housing. In an aspect, by using information provided by homeseekers and/or provided by third parties about these homeseekers, an understanding of those sets of needs can be developed and used to tailor content intended for homeseeker use in assessing properties for purchase and/or rental, and the tailored content can be synthesized within a generated needs profile for the homeseekers.

These embodiments are collectively referred to herein as “User Profile Tools and Techniques.” In some embodiments, the user profile tools and techniques may be applied to and/or otherwise incorporated as part of the homeseeker search tools and techniques, while in other embodiments, the user profile tools and techniques may be broadly applied to any field or application that employs user preference profiles, including, without limitation, various marketing fields (such as automobile marketing, real estate marketing, or consumer product marketing, to name a few examples), software applications that store user preferences, and/or the like. Merely by way of example, the disclosed techniques could be applied to all sorts of durable goods (from washing machines to treadmills), tools, books, music, movies, computers, orange juice, and/or the like. Essentially, this approach would work for any product that has more than a few dimensions with regard to which people's preferences might vary, which might include virtually any product that is not entirely a commodity.

According to some embodiments, a computer might receive a list of real estate listings, each pertaining to, and including a plurality of attributes about, an available home for purchase or rent/lease. The computer might collect information about a plurality of factors relating to a prospective homeseeker, generate a user profile based at least in part on the plurality of factors, and infer a prioritized list of real estate listing characteristics to satisfy the user based on a prioritized list of homeseeker criteria that is part of the user profile. To generate the user profile, the computer might collect data about the user from a variety of sources, including, without limitation, the user himself or herself, social network servers and/or databases, data collection servers and/or databases that collect data about the user (knowingly or unbeknownst to the user), and/or the like. The data might be related to homes, related to non-home-related matters (e.g., information relating to a number of preferences of the user, including car preferences, travel preferences, smart phone preferences, etc.), or both.

The data might also pertain to people associated or otherwise related to the user, who might include family/relatives, close friends, acquaintances, former/current classmates, former/current co-workers, enemies, frenemies, celebrities whom the user likes/follows, celebrities whom the user hates/avoids, and/or the like (collectively, “friends”). Such data might include what these friends like or hate, where these friends live or work relative to the user, home-related information about these friends, non-home-related information about these friends, and/or the like. With such information about the user's friends, the user profile can be made to be more relevant (and more fully dimensioned) to the user as it will include information about his or her friends, whose social connection to the user might influence homeseeker choices. Such information about the user and his or her friends may also be used to generate other user preference profiles for the user that are non-home-related.

The computer might subsequently generate and prioritize a list of potential homes from the list of real estate listings, based on comparisons, and at least in part on matches, between the prioritized list of real estate listing characteristics and attributes of at least some potential homes in the listings. The computer might subsequently display the prioritized list of potential homes to the user. In some cases, some features of each potential home may be emphasized or de-emphasized/eliminated, based on the user's homeseeker criteria. The prioritized list of potential homes may be updated based on updated information about the user that are compiled in updated versions of the user's profile, which might be updated based on additional information collected about the user.

Homeseeker Search Tools and Techniques:

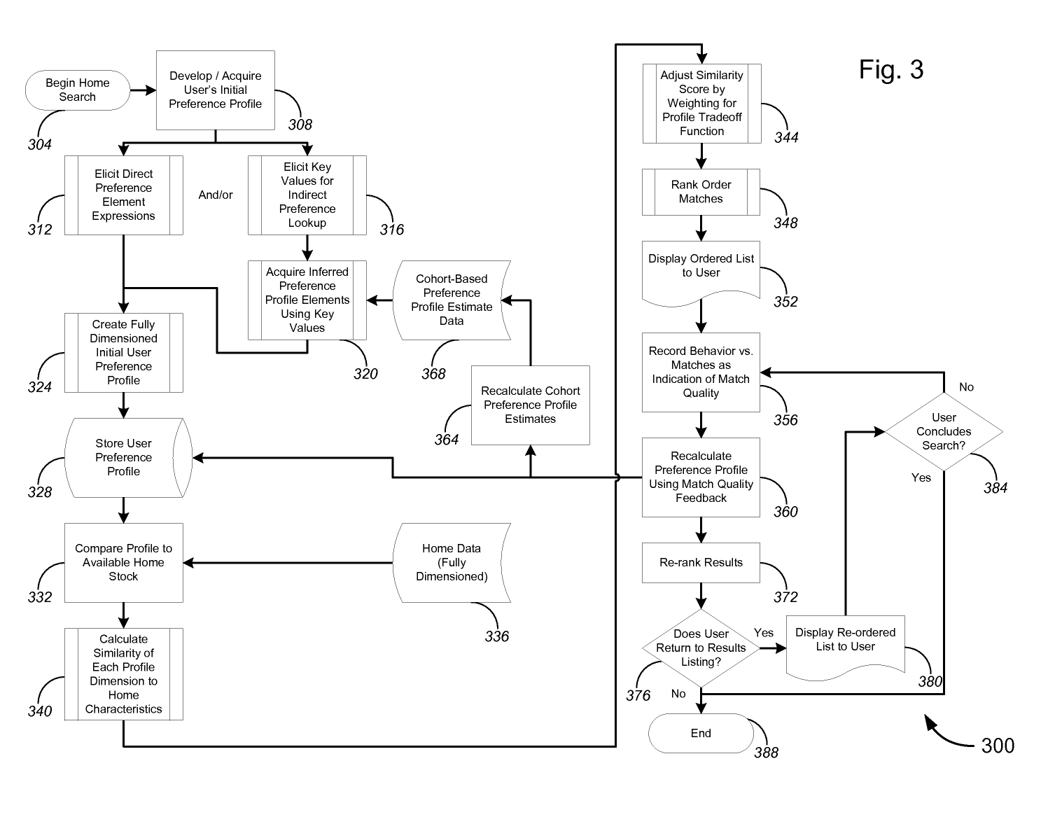

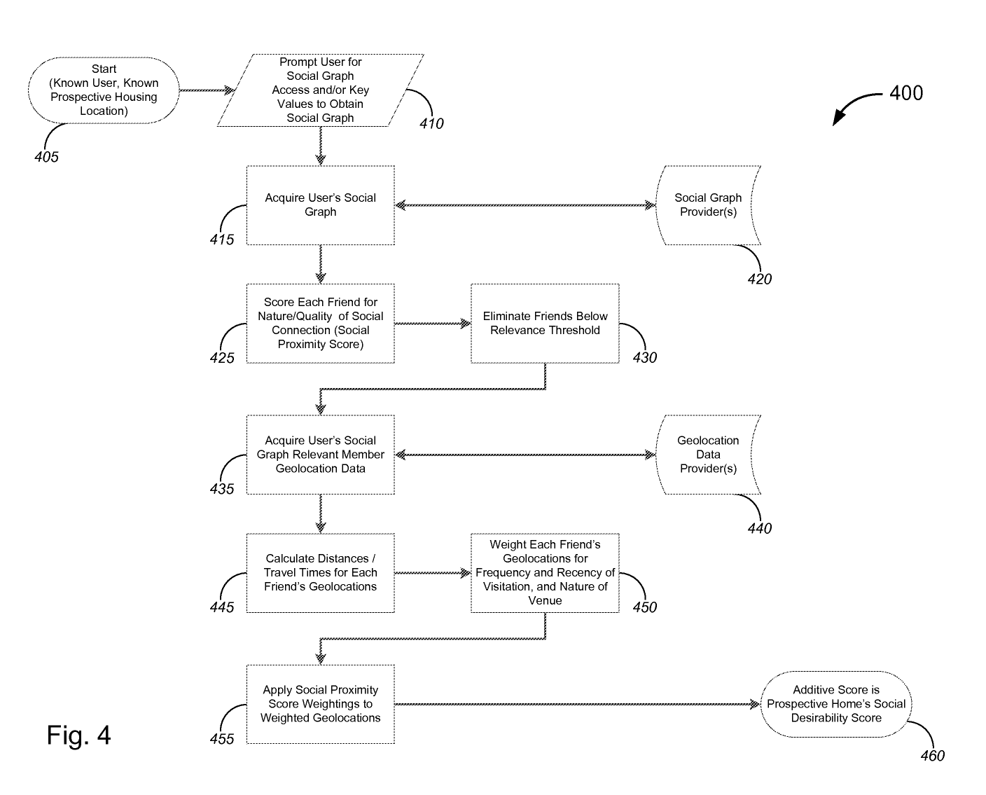

A method of determining the suitability of a prospective residence is illustrated by FIG. 3. This method can take into account any combination of the factors described herein below. FIG. 4 illustrates a method of determining the desirability of a residence based on the locations of associates (specifically, although not limited to, friends). This method can take into account any combination of the factors or values described herein.

(1) Factor-Based Determination of Suitability of Prospective Residences

People evaluate a home as a purchase or rental prospect by explicitly and implicitly comparing their personal set of needs and tradeoffs against their belief in the home's ability to deliver benefits along each of the dimensions that satisfy, or partially satisfy, those needs, and choose homes from the available choices such that satisfaction is likely to be maximized given the tradeoffs that are embodied in the available home choices.

Home seeker needs are significantly different for each individual buyer/renter, and each home seeker's tradeoff functions are significantly different. Home seekers may or may not be able to fully or partially express their needs and desires, but even if they cannot express them, their needs and desires are still implicit in their search process. Home seekers require that homes provide values acceptable to them in one or more of the following main areas: (1) Desired price/cost of ownership or use; (2) Basic housing needs/wants; (3) Investment factors; (4) Psychological factors; (5) Proximity factors; (6) Inclusion in a defined area; and (7) Heritage factors.

Desired price/cost of ownership or use might include, without limitation, price if purchasing, or rent if renting or leasing; terms of financing; tax deductibility and/or other tax-related effects, such as amortizations; utility costs; homeowners association (“HOA”) dues and other fees; easements, restrictive deed terms, and/or other expense-inducing or resale impairments; expectation of resale value over a variety of time periods; expectation of future ability to use the home's expected increased value to fund further loans, to be used for renovations or other expenses; potential rental or sublet income; and/or the like.

Basic housing needs/wants might include, but are not limited to, size of the home; interior layout, including number and arrangement of bedrooms, bathrooms, and other living spaces; size and features of the lot (e.g., level or inclined, dry/wet, presence/absence/size of backyard, presence/absence/size of pool/hot tub, presence/absence/size of deck/patio, presence/absence/size of outdoor kitchen, and/or the like); construction factors (e.g., type of construction of, quality of, and/or recency of build and/or renovation/retrofit, or the like); safety (e.g., resistance or susceptibility to fire, floods, weather, and other natural forces; intrusion resistance; visibility; access control; and/or the like); geological and environmental features of the location (e.g., hilltop, hillside, landfill, bedrock, water features, microclimate, expansive soils, and/or the like).

Investment factors might include, without limitation, expected appreciation and/or residual value; tax benefits; and/or the like.

Psychological factors might include, but are not limited to, aesthetics (e.g., architectural style, finishes, landscaping, aesthetic features, and/or the like); intended use (e.g., for shelter, for entertainment, and/or the like); privacy; luxury; view; self-actualization facilitation (e.g., gourmet kitchen, pool, hot tub, gym, entertaining features, and/or the like); reputation enhancement (e.g., being in an upscale/artsy/fashionable/etc. neighborhood, home designed by noted architect, and/or the like); character of the neighborhood (e.g., traditional residential, upscale, up and coming, melting pot, hip/cool, etc.); character of neighbors (e.g., demographics); safety of the neighborhood (e.g., crime densities, proximity and responsiveness of fire, police, and/or medical services, etc.); and/or the like.

Proximity factors might comprise proximity to people and/or places including, without limitation, friends, family members, and other persons; workplace or vocational locations; recreational facilities; geological features (e.g., ocean, beaches, mountains, lakes, rivers, and/or the like); historical features (e.g., notable buildings, battlefields, and/or other landmarks); desirable schools and/or school district membership; public transit access; freeway access; access to shopping, dining, exercise, and/or other convenience or avocational facilities (including number, type, quality, and distance thereof); fire, police, and/or medical services (including responsiveness thereof); and/or the like.

Inclusion in a defined area might include inclusion in a defined political, jurisdictional, incorporated, and/or government-designated area, which might be for voting, membership, and/or prestige purposes. Such areas might include, but are not limited to, towns, cities, or other municipalities; school districts; congressional district, city council zone, or other political subdivision; zip or postal code; and/or the like.

Heritage factors might include, without limitation, designation or lack thereof of the property or residence as a protected or non-protected historical site by a governmental or private body; history of previous generations of the user's or homeseeker's family having or not having residence or residences in the specific or general area; and/or the like.

A home's utility in delivering benefits is a function of its endogenous properties (e.g., size, lot size, layout, features, equipment, construction, materials, age, finishes, landscaping, levelness of ground, aesthetics, etc.) and exogenous properties which are functions of the home's surroundings (e.g., crime rate of neighborhood, cleanliness of neighborhood, demographics of neighbors, quality of schools nearby and/or in the school district, distance to mass transit stop, distance to parks, shopping and amenities within walking distance, etc.). Every residential real estate property has a unique set of endogenous and exogenous qualities that determine the property's utility in satisfying a plurality of homebuyer or renter needs. By quantifying these needs and the tradeoffs potential customers are willing to make, and by quantifying a residential property's ability to deliver relevant benefits on a plurality of dimensions, the degree to which a given potential home is likely to satisfy a particular homeseeker can be determined.

When this match is calculated between a user and multiple residential properties, these results may be presented in a rank-ordered display, in which the items displayed most prominently are more likely to suit the user's preferences than items displayed less prominently.

As a given individual continues to use such a system over time, the system can use information about the user's behavior to adjust the relative importance of each dimension embodied by a property. In this way, the system's performance with respect to the user will likely improve over time. Furthermore, when multiple users who are members of a potential future residential social unit (e.g., a family) use the system, the system can optimize for the union of preferences of all of the users at once. Additionally and/or alternatively, the system can use user behavior to adjust its initial estimates of the relative importance of each dimension over time, on a cross-user basis. These initial estimates may be adjusted for each demographic, each locality, or globally.

In some aspects, a method might comprise using a plurality of endogenous and/or exogenous factors to determine the suitability of a prospective residence for a prospective home buyer or renter (“user” or “homeseeker”). The plurality of factors might include, but are not limited to, one or more of the following factors: factors relating to the likely financial costs or other financial terms having to do with a potential purchase or lease transaction; price at which the residence is offered for sale; rental cost at which the residence is offered for rent or lease; an item arising from a potential loan for financing of the purchase (which might include, without limitation, initial down payment of the loan, initial interest rate of the loan, term of the loan, balloon payment at the end of the loan term, likely tax treatment of the loan, and/or the like); amount of prospective HOA dues associated with the residence in question; amount of residence-related membership fees (other than HOA dues) associated with the residence in question; presence or absence of an easement that may impair resale value or create a need for legal expenses; output of a mathematical model that predicts future resale value of the residence in question over one or more specific time periods; factors relating to a predicted ability or lack of ability to obtain future loans on the property in order to fund future renovations or repairs of the residence or improvements on the property (in which case, future renovations might be predicted by a mathematical model taking into account the current property status, or by a mathematical model taking into account the current and/or past status of one or more properties in the immediate neighborhood and/or other surrounding areas); the likely amount of rent that the property owner would be able to charge a third party for that third party's full or partial use of the residence as a residence for those third parties; factors relating to a basic housing need of a resident; factors relating to proximity of the property to something or someone else; and/or the like.

In some embodiments, one of the items (e.g., item arising from a potential loan, etc.) might include a predicted end-user cost for providing service for a specific utility at the residence in question. In some cases, prediction of providing said utility service might be based in part or in full on a model taking into account average local costs for said utility. Alternatively, prediction of providing said utility service might be based in part or in full on historical usage of the user in question for said utility at one or more other locations. In some instances, prediction of providing said utility service might be based in part or in full on a model taking into account average local costs for said utility at the previous locations of historical usage.

Merely by way of example, factors relating to a basic housing need of a resident might include, without limitation, the living area of the residence; the gross area of the lot on which the residence is located; a feature of the lot on which the residence is located (e.g., grade, presence or absence of water, etc.); the presence or absence of a feature of the layout of the living area(s) of the residence; the presence or absence of a feature of the construction of the residence; the presence or absence of a safety feature of the residence; the presence or absence of a geological or environmental feature of the property; the amount of expected appreciation over a given time period, or residual value of the property asset after a given time; the amount of expected tax benefit of owning the property over a given time period; a characteristic of the landscaping of the property; a psychological aspect of ownership or rentership of the property in question; and/or the like.

In some embodiments, the living area of the residence might be compared to living areas for others in the same demographic segment as the user. In some instances, the living area of the residence might be compared to the living areas of one or more residences where the prospective resident or homeseeker has resided in the past. In some cases, a comparison might be made to progression in life stage of the prospective resident or homeseeker.

According to some embodiments, the gross area of the lot on which the residence is located might be compared to corresponding areas for others in the same demographic segment as the user. In some cases, said area might be compared to the corresponding areas of one or more residences where the prospective resident or homeseeker has resided in the past. In some instances, a comparison might be made to progression in life stage of the prospective resident or homeseeker.

In some aspects, presence or absence of the feature of the lot on which the residence is located might be compared to the presence or absence of the feature in residences of others in the same demographic segment as the user. In some instances, presence or absence of the feature might be compared to the presence or absence of the feature in one or more residences where the prospective resident or homeseeker has resided in the past. In some cases, a comparison might be made to progression in life stage of the prospective resident or homeseeker.

The presence or absence of a feature of the layout of the living area(s) of the residence might include, but is not limited to, number of bedrooms, arrangement of bedrooms, presence or absence of a room or set of rooms suited to a particular use (e.g., master suite, guest house, children's wing, etc.). In some embodiments, presence or absence of the feature might be compared to the presence or absence of the feature in residences of others in the same demographic segment as the user. In some cases, presence or absence of the feature might be compared to the presence or absence of the feature in one or more residences where the prospective resident or homeseeker has resided in the past. In some instances, a comparison might be made to progression in life stage of the prospective resident or homeseeker.

The presence or absence of a feature of the construction of the residence might include, without limitation, architectural style, construction materials (e.g., wood, steel, aluminum, tile, slate, etc.) both for general infrastructure but also for particular use (e.g., countertop, bathroom, backyard landscaping, etc.); recency of construction; quality of construction (e.g., luxury or standard fittings); presence or absence of a specific fitting or type of fitting; or presence or absence of a specific architectural or aesthetic feature (e.g. vintage moldings, tall ceilings, etc.); and/or the like. In some instances, presence or absence of the feature might be compared to the presence or absence of the feature in residences of others in the same demographic segment as the user. In some embodiments, presence or absence of the feature might be compared to the presence or absence of the feature in one or more residences where the prospective resident or homeseeker has resided in the past. In some cases, a comparison might be made to progression in life stage of the prospective resident or homeseeker.

The presence or absence of a safety feature of the residence might include, without limitation, reduced visibility of living areas from public areas; access control; resistance or susceptibility of the residence or related improvements to fire, wind, earthquake, snow, rain, hail, and/or other natural forces; resistance or susceptibility of the residence or related improvements to armed or unarmed intrusion by one or more third parties; and/or the like. In some cases, presence or absence of the feature might be compared to the presence or absence of the feature in residences of others in the same demographic segment as the user. In some instances, presence or absence of the feature might be compared to the presence or absence of the feature in one or more residences where the prospective resident or homeseeker has resided in the past. In some embodiments, a comparison might be made to progression in life stage of the prospective resident or homeseeker.

The presence or absence of a geological or environmental feature of the property might include, but is not limited to, topographic characteristics of the property (e.g., hillside, hilltop, flat, valley, etc.), surface characteristics of the property (e.g., bedrock, landfill, etc.), biological characteristics of the property (e.g., the presence or absence of trees or bushes of a particular species or category, etc.), and/or the like. In some embodiments, presence or absence of the feature might be compared to the presence or absence of the feature in residences of others in the same demographic segment as the user. In some cases, presence or absence of the feature might be compared to the presence or absence of the feature in one or more residences where the prospective resident or homeseeker has resided in the past. In some instances, a comparison might be made to progression in life stage of the prospective resident or homeseeker.

According to some embodiments, the amount of expected appreciation over a given time period, or residual value of the property asset after a given time, might be related to typical values for property owned by other members of the user's demographic, related to the current or future life stage of the prospective resident or homeseeker, or related to both.

In some embodiments, the amount of expected tax benefit of owning the property over a given time period might be related to typical values for property owned by other members of the user's demographic, related to the current or future life stage of the prospective resident or homeseeker, or related to both.

A characteristic of the landscaping of the property might include, without limitation, presence or absence of a specific landscaping feature (e.g., trees over a certain height, a waterfall, forest path, a bridge, etc.). In some cases, presence or absence of the landscaping feature might be compared to the presence or absence of the feature in residences of others in the same demographic segment as the user. In some instances, presence or absence of the landscaping feature might be compared to the presence or absence of the feature in one or more residences where the prospective resident or homeseeker has resided in the past. According to some embodiments, a comparison might be made to progression in life stage of the prospective resident or homeseeker.

A psychological aspect of ownership or rentership of the property in question might include, but is not limited to, applicability of the property for a specific use; the degree to which external privacy is available on the property (i.e., the degree to which individuals on the property are shielded from view or hearing from those not on the property, or vice versa); the degree to which internal privacy is available on the property (i.e., the degree to which individuals on the property are typically shielded from view or hearing from any others on the property during normal use); the degree of perceived luxury available to users of the property; the presence or absence of a desirable view from the property; the potential for the facilitation of self-actualization provided by a feature of the property (e.g., gourmet kitchen, pool, hot tub, gym, theater, workshop, etc.); the potential for reputation enhancement related to a feature of the property or neighborhood; and/or the like.

Applicability of the property for a specific use might include, but is not limited to, shelter, specific types of entertainment (e.g., dinner parties for up to a certain number of guests, outdoor barbeque parties, swimming parties, etc.) or certain types of educational activities (e.g., cooking classes, film clubs, etc.). The presence or absence of a desirable view from the property might include presence or absence of a specific kind of desirable view from the property (e.g., of a mountain, a valley, a river, an ocean a cityscape, etc.), the extent to which the desirable view extends through a large area of the property and/or is available from multiple vantage points (e.g., multiple windows, rooftop, patio, balcony, etc.), or both. In some embodiments, importance of the potential for the facilitation of self-actualization provided by a feature of the property might be weighted by the life-stage of the user. According to some aspects, importance of the potential for reputation enhancement related to a feature of the property or neighborhood might also be weighted by life-stage of the user. In some cases, the reputation concerned might be a reputation in a specific area (e.g., being arty, fashionable, cutting-edge, rich, tasteful, etc.), and importance of this feature might be weighted by life-stage of the user.

Regarding factors relating to proximity of the property to something or someone else, the relevant proximity might be to the user's friends, family, or other persons significant to the user, including, but not limited to, celebrities and politicians, etc. In some cases, the relevant proximity might be to the user's workplace, vocational, or avocational location. In some instances, the relevant proximity might be to a recreational facility, which might be one which the user is known to frequent, one which the user is known to desire to frequent, a type of facility in which the user has demonstrated interest, or one which demographic profiling indicates that the user is likely to frequent or desire to frequent and/or otherwise desire the proximity thereof. According to some embodiments, the relevant proximity might be to a geological feature, including, but not limited to, beach, mountain, or lake, etc. In some cases, the relevant geological feature might be one which the user is known to have visited, one which the user is known to have registered an interest in, or one that is similar to one which the user has visited or in which the user has registered an interest. In some embodiments, the relevant proximity might be to a historical feature. In some instances, the relevant historical feature might be one which the user is known to have visited, one which the user is known to have registered an interest in, or one that is similar to one which the user has visited or in which the user has registered an interest.

In some aspects, the relevant proximity might be to a school or where the location indicates membership in a school district. In some instances, one of the factors might relate to the property being within a particular area, which might be a school district. In some cases, the school or school district in question might be rated by an agency, individual, or other entity that has a practice of rating schools or school districts. The scale in question may be one of overall desirability or may be specific to a single attribute of the school or school district, including, but not limited to, foreign language instruction, specific foreign language instruction (e.g., French, Latin, German, etc.), student body composition on any dimension, or student body proficiency in a specific language, and/or the like.

According to some embodiments, one of the factors might relate to the property being within a specific geographical or political area. In some cases, the area in question might be a city, town, or other municipal area. In some instances, the area in question might have a history of political orientation similar to or different from the political orientation of the user. In some aspects, the area in question might be a site notable for its historical significance. In some instances, the historical significance in question might be general, including, but not limited to, historically-important houses/buildings, businesses, monuments, or battlefields. In some cases, the historical significance in question might relate to the history of the user's family.

In some instances, the relevant proximity might be to public transit access (including, without limitation, bus, tram, train, ferry, or subway, etc.), to freeway access, to a shopping, dining, exercise, or other convenience or avocational facility, and/or the like. The relevant facility, in some cases, might be one in which the user has a demonstrated interest, one in which the user may be expected to have an interest based on the user's profile, one in which the user may be expected to have an interest based on demographic profile information, one which is highly rated by a rating system which incorporates rating information from users, and/or the like.

In the description above, the user in question might be any individual who can be expected to reside at the property in question, including, without limitation, members of the immediate family of the prospective purchaser or renter. According to some embodiments, a composite score might be determined by combining weighted scores from one or more of the techniques discussed above, or from each of the techniques discussed above. In some instances, a learning algorithm might be used to improve results by adjusting the relative weights used to combine the various aspects and embodiments described above.

(2) Association-Based Determination of Suitability of Prospective Residences

People generally like to live near their friends, colleagues, and families (collectively, “friends”), all else being equal. By using data concerning the locations of residences, places of work, and other venues frequented by members of a subject's social, vocational, avocational, family, affinity, or other group, some aspects of the desirability of a particular potential residence may be determined. Similarly, for some individuals, a close physical relationship may be undesirable; by using the same kind of location data, this may also be used to inform the desirability of a particular potential residence.

Social networking services, mobile data service providers, telecommunications service providers, data brokerage services, and other online services make “check-in,” residential address, work/study location, “bread-crumb trail,” and other location data supplied explicitly and implicitly by their users available to third parties. Additionally, these services provide data which might describe relationships among users (i.e., users' “social graph”) and/or data, which can be used to infer relationships (e.g., telecommunications connection records, transaction, travel, and co-location data). By analyzing the historical location data (e.g., venue presence data/check-in data, bread-crumb trails, and static geo-locations) of members of a user's social graph and/or implied relationship network, in relation to a potential home's location, that potential home can be scored in terms of social locational desirability for that user; this score can help the user gauge an important dimension of the overall desirability of the prospective home.

At its simplest level, a potential home would score a single dimensional numeric score derived from the proximity and frequency of presence of friends relative to the potential home. Refinements to this scoring could weight friends, relatives, and colleagues differently, and/or give different scores for each; scores could be weighted by the proximity of the social relationship (e.g., location information pertaining to explicitly designated “close friends” or friends exhibiting strong ties (i.e., in the network graph sense) would be weighted more heavily than that pertaining to a relationship with a colleague that is not so designated, or is a loosely-coupled friend), or may in fact be potentially weighted negatively when pertaining to a person who is actively disliked or with whom desirability of relative location otherwise increases with distance. Additionally, the weighting factor need not be simply linear, as potentially in the case of children who do not wish to live either too close to or too far from their parents. Scores could be further adjusted by weighting for distance (both distance “as the-crow-flies” and distance via a plurality of practical route types) from the prospective residences to friends' locations.

As a given individual continues to use such a system over time, the system can use information about the user's behavior to adjust the relative importance of each dimension embodied by a property. In this way, the system's performance with respect to the user will likely improve over time. Furthermore, when multiple users who are members of a potential future residential social unit (e.g., a family) use the system, the system can optimize for the union of preferences of all of the users at once. Additionally and/or alternatively, the system can use user behavior to adjust its initial estimates of the relative importance of each dimension over time, on a cross-user basis. These initial estimates may be adjusted for each demographic, each locality, or globally.

In some aspects, a method might comprise using a present or historical location of another person to judge the desirability of a particular residence location for a user. In some cases, the other person in question might be known to have some sort of relationship (or “connection”) with the user. In some embodiments, the relationship might be defined at least in part by the presence of a connection, either bidirectional (i.e., reciprocal) or unidirectional (i.e., from one to the other, but not from both) between the user and the other person on an online service, often called a “social network.” In some cases, the relationship might be defined at least in part by the presence of a first-degree (i.e., direct) connection between the user and the other person, as discovered by direct inquiry of the user in question. In some instances, the relationship might be defined at least in part by data available from a third party, including, but not limited to, police reports, legal documents, phone records, financial records, or private individuals, and/or the like.

According to some aspects, the relationship might be a direct relationship, with no intermediate parties present on the shortest connection path between the two individuals. In some cases, the connection might be reciprocal (that is, where each of the parties is directly connected to the other). In some instances, the connection might be unilateral (that is, where one of the parties connects to the other but there is no inverse connection, as in the case of a “following” relationship, or the like). In some embodiments, the connection might be qualified by a type of relationship, including, but not limited to, mutually-declared friend (i.e., where each has designated the other as a friend), unilaterally-declared friend (i.e., where exactly one of the parties has designated the other a friend), mutually-declared family, unilaterally-declared family, acquaintance, family member, close family member, enemy, or frenemy, and/or the like. In some cases, the desirability of closeness between the parties might be moderated by a factor dependent on the kind of relationship, by an explicit indication of said desirability by the user in question, by a factor determined by the output of a machine learning algorithm which examines data concerned with the available interactions of the two parties, or any combination of these factors. In some instances, data about the interaction of the two parties might be retrieved from an online service, notably including, but not limited to, “social networking” services.

In some aspects, the relationship might be an indirect connection between the user and the other person. In some instances, the relationship might be a second-degree connection (i.e., via a single intermediate party) between the user and the other person, a third-degree connection (i.e., via two intermediate parties) between the user and the other person, or a fourth or greater-degree connection (i.e., via three or more intermediate parties) between the user and the other person.

Merely by way of example, in some embodiments, present and/or historical location of the person in question might be determined via an online service, notably including, without limitation, those online services which provide a “check in” feature allowing users to specify their own physical locations.

In some cases, data concerning multiple relationships between the user and other people might be combined. Each relationship might have been discovered via a combination of two or more of the above aspects and embodiments. The result of the combination might be a combined overall desirability score for a given physical location. In some instances, the data from the various relationships and locations might be combined using a machine learning algorithm.

(3) Personalization and Facilitation of Search Process for Residential Real Estate

Current methods for online searches are “one size fits all” and require the user to specify a few simple, least-common-denominator features as search criteria, and force the user to sort through long, un-ranked, or poorly-ranked search results. By using additional data sources, particularly external data sources which facilitate building a multivariate preference model of the searcher's utility function for residential real estate, it is possible to provide a much more efficient and effective search experience. Furthermore, when connecting to external services in order to provide this data, it becomes feasible to easily facilitate the prospective homeseeker's analysis of properties by enabling structured workflow among stakeholders. Because use of these data sources and communications facilities requires, and results in, the creation of models of residential real estate preferences, the system can also be used to assess residential real estate products in terms of their sales potential and fit against notional customer types.

Various embodiments provide tools and techniques (including, without limitation, methods, systems and/or software that implement those tools and techniques) for personalizing and facilitating the search process for residential real estate and providing predictive models of real estate preferences. Such tools and techniques include those described in the Related Application, as well as those described below. These methods, tools, and techniques can be implemented together and/or combined in variety of ways, in accordance with the various embodiments.

(a) Method for Using Behavioral and Psychographic Modeling in Profiling Prospects in Order to Determine their Suitability for a Particular Real Estate Product

Any residential real estate property can be characterized on a plurality of dimensions, which describe its ability to deliver benefits sought by homeseekers—for instance, “luxury,” “suitability for entertaining,” “school quality,” and so forth.

Using a variety of techniques, psychological and behavioral characteristics of typical buyers of a specific real estate product may be determined. These characteristics may be derived from data concerning previous purchasers, from focus groups, from ad-hoc analysis, or from other means or sources. These characteristics can be mapped to needs that can be delivered by housing choices. For instance, “status seeking” prospective homeseekers will have a high need for “luxury”; frequent fine diners will have a high need for a home in close proximity to white tablecloth restaurants.

By comparing the vector of benefits of a prospective home to the vector of needs of a prospective buyer, using well-known information retrieval techniques, the likely suitability of that home for the buyer can be determined.

(b) Method for Using Location of Vocation, Avocation, and/or Other Necessary or Likely Frequent Destinations to Determine Suitability of a Prospective Residence

By analyzing factors relating to a person's place of work, study, or other frequently visited venue, the suitability of a prospective residence can be determined, at least in part. A critical factor in determining the desirability of a residence is whether it will enable a pleasant and/or efficient trip to and from work (“commute”) or other frequent or important destinations. By taking into account a user's transport preferences (i.e., mass transit, car, bicycle, walking, etc.), the distance from the prospective home to the commute destination, the time taken for the commute, potential for alternate routes, conditions along the commute (e.g., scenic, high crime, bike lane, traffic conditions, etc.), venues along the route (e.g., gym, food market, shopping, club, etc.), the quality of the commute can be determined.

Additionally, knowledge of a user's residence (or prospective residence) and location of their work/study/etc. can be of determinative value in inferring a user's demographic, psychographic, and behavioral profile; that is, people who are similar in terms of where they live and work tend to be similar in other aspects. By applying knowledge of a prospective residence's neighbors' demographic, psychographic, and/or behavioral profiles, the suitability of that residence for a user can be assessed for how well it matches that user, and therefore how strongly they are likely to prefer that residence.

(c) Method for Using a History of Prior Residences to Predict Affinity for Potential Future Residences

Individuals tend to have stable preferences for the qualities they seek in homes and the neighborhoods they wish to live in, and those preferences tend to be shared among individuals sharing similar demographic, psychographic, and/or behavioral profiles. To the extent that individuals' preferences for the qualities they seek in homes and neighborhoods change over time, those changes can be largely attributed to change in life-stage-related demographic, psychographic, and/or behavioral evolutions, which are generally predictable. By analyzing a history of a user's residences, their preferences for qualities they seek in future residences can be predicted. The means by which a user's history of residences is analyzed include features endogenous to the property (including, but not limited to, square footage, number of bedrooms, size and equipment & finishes in kitchen, etc.) and factors which are functions of exogenous features (including, without limitation, proximity to transit, proximity to parks, amount and nature of shopping within walking distance, neighborhood density, neighborhood household income, quality of schools, etc.). All else being equal, it is likely that users will look for similar bundles of features in future properties, as moderated by a possible progression in life-stage. For example, people whose children have moved out may demonstrate a new preference for fewer bedrooms, and people who are becoming elderly may demonstrate a new preference for single-floor homes. Analysis of residential preferences may be further refined by correlating the user's housing feature bundle preference (as expressed by their history) to homeseeker segment archetypical profiles, and then correlating prospective homes and neighborhoods to those profiles using profiles of homes and/or people in the prospective neighborhoods.

(d) Method for Using Estimated all-Inclusive Monthly Cost as a Search Key for Suitable Residence

Homebuyers typically partially determine the suitability of a residence based on how much cash out of pocket they will have to expend on a periodic basis. However, residential real estate search is typically performed using the lump-sum price of homes. By taking into account likely prospective mortgage terms, taxes, homeowner association fees, utility fees, maintenance costs, and other expenses in addition to the base cost of the home, it is possible to project expected periodic expenditure for a home. By enabling this calculation within a real estate search system, it is possible to allow search based on periodic expenditure, making it easier for homebuyers to find appropriate prospective homes.

(e) Method for Using Estimated Total Cost of Ownership to Determine Suitability of a Residence

Home purchasers tend to base their decisions in part on their estimates of the total cost of ownership (“TCO”) of a home. However, for most home purchasers, this is based on impressionistic information, guesswork, and “gut feel” because they generally lack access to analytical tools and good data. By acquiring supplemental data on homes, applying models to primary and supplemental home data, and systematizing the presentation of that information to homebuyers, they can thereby be enabled to make more confident determinations of the suitability of a home. Additionally, by applying automated TCO analysis to homes, homes can be rank-ordered for presentation to users, enabling a more streamlined search process.

Information used in TCO analysis for homes might include, without limitation, base price, property taxes, income tax rate of the potential purchaser or a model purchaser, mortgage interest rate for the potential purchaser or a model purchaser, other mortgage terms (including origination fees, points, payment schedule, balloon(s), refinancing options, and/or the like), amount to be financed by the potential purchaser or a model purchaser, projected closing costs (including title search, title insurance, escrow costs, inspection costs, and/or the like), projected homeowners' insurance costs, HOA or similar fees, expected maintenance costs, expected retention period of home, projected value change of home (e.g., terminal value), historical prices of comparable homes, third party local market projections, economic and demographic local market projections, expected volatility of value of the home over a retention period, volatility premium, projected rental income, and/or the like.

(f) Method for Using Social Networks to Mediate Workflow for Home Buying Process

The process of searching for and buying a home is complex, involving multiple people in the information search, decision, and transaction processes. It is desirable for all individuals involved with these processes to have a clear and explicit workflow that automates message passing required by the process. Social networking services provide a message passing and social relationship modeling infrastructure that can be used in a home search and buying process.

With access to a user's social network service, a workflow system for home buying can solicit input from a potential homebuyer as to which of his or her friends, relatives, associates, and/or advisors should be consulted during various stages of the process. The system may optionally allow the specification of different sets of friends, relatives, associates, and/or advisors for different aspects of the process. For example, a small set of people might be asked for feedback about an initial set of properties, but a much larger set could be asked for feedback about the selected few of those properties in which the user expresses more interest. Friends, relatives, associates, and/or advisors with specific expertise could be consulted when questions arise that intersect such expertise. For example, a user could indicate a few people who might usefully be asked about electrical problems, a few about swimming pools, etc.

Once these lists have been established by the user, the workflow system can subsequently include communications with those users using a variety of communications media, including, but not limited to, e-mail, short message service (“SMS”) messaging, multimedia messaging service (“MMS”) messaging, web-based messaging, and/or the like.

These lists may be revised by the user at any time, and people may likewise request that the system not communicate with them as part of this process (or at all).

(g) Method for Using Behavioral, Psychographic, and/or Geographic Information System (“GIS”) Models for Site Selection and Feature Configuration of Residential Real Estate Products.

Psychological instruments exist which produce scores for individuals on a variety of dimensions, including, without limitation, such personality aspects as introversion/extroversion, novelty-seeking, self-confidence, etc.

Additionally, it is possible to determine various data pertaining to homes, including both aspects of the home itself (e.g., number of bathrooms, size of garage, etc.) and aspects of the surrounding area (e.g., number of bakeries within a five minute walk, number of gas stations on the way to the highway, etc.).

Using these two types of data, it is possible to analyze the relationships between various personality features and revealed preferences for specific home/neighborhood features.

This analysis can be coupled with psychographic and GIS information for a user in order to predict a specific or notional target user's demand for a specific property.

(h) Method for Using Aggregated User Data to Predict Demand for a Defined Basket of Features, or an Individual Feature/Value, of a Residential Real Estate Product.

People reveal their preferences for real estate products by several sets of behaviors, including, but not limited to, searching (“what do they search for?” includes both home and neighborhood features, and manual ordering of features); clicking on search results (“what do they target for examination in more depth?”); spending time viewing the display for a given property, proactively clicking to view on photos, etc.; asking people (e.g., agents, social connections, etc.) for opinions about a given property or set of properties; buying or selling a property; engaging or firing an agent; and/or the like.

Real estate products may be viewed as collections of features. For example, a particular house might have a certain number of bathrooms, a swimming pool, and a formal garden, while another house might have a different number of bathrooms, a four-car garage, and a maid's quarters but no garden and no pool. Because most homebuyers do not build their own houses from scratch, their preferences must perforce be directly revealed only in aggregate. However, mathematical models may be constructed to determine which specific features are actually the most meaningful to individuals and/or groups of like individuals, and to determine what the user preferences are for features in comparison with other features.

Collecting this data across a corpus of users can provide current (e.g., timely and/or, in some cases, near-real-time) information about what features are in demand in a particular area. In this case, “area” may refer to a very specific area such as a city block or neighborhood, a city, a metropolitan area, or even a country or grouping of countries. As current (e.g., timely and/or, in some cases, near-real-time) data is collected, historical data is established and this historical data is valuable for predicting trends within and across any geographical region that is likely to be meaningful.

In some aspects, a method might comprise using behavioral and psychographic modeling in profiling prospects in order to determine their suitability for a particular real estate product. In some embodiments, a method might comprise using location of vocation, avocation, or other necessary or likely frequent destinations to determine suitability of a prospective residence. In some cases, a method might comprise using a history of prior residences to predict affinity for potential future residences. In some instances, a method might comprise using estimated all-inclusive monthly cost as a search key for suitable residence. According to some embodiments, a method might comprise using estimated total cost of ownership to determine suitability of a residence. In some embodiments, a method might comprise using social networks to generate workflow for home buying process. In some instances, a method might comprise using behavioral, psychographic, and GIS models for site selection and feature configuration of residential real estate products. In some cases, a method might comprise using aggregated user data to predict demand for a defined basket of features, or an individual feature/value, of a residential real estate product.

User Profile Tools and Techniques:

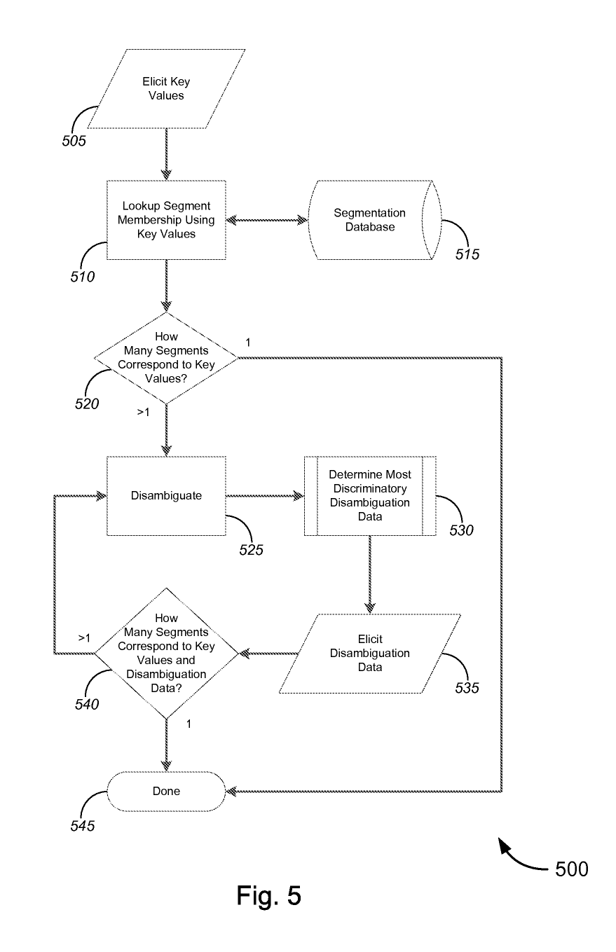

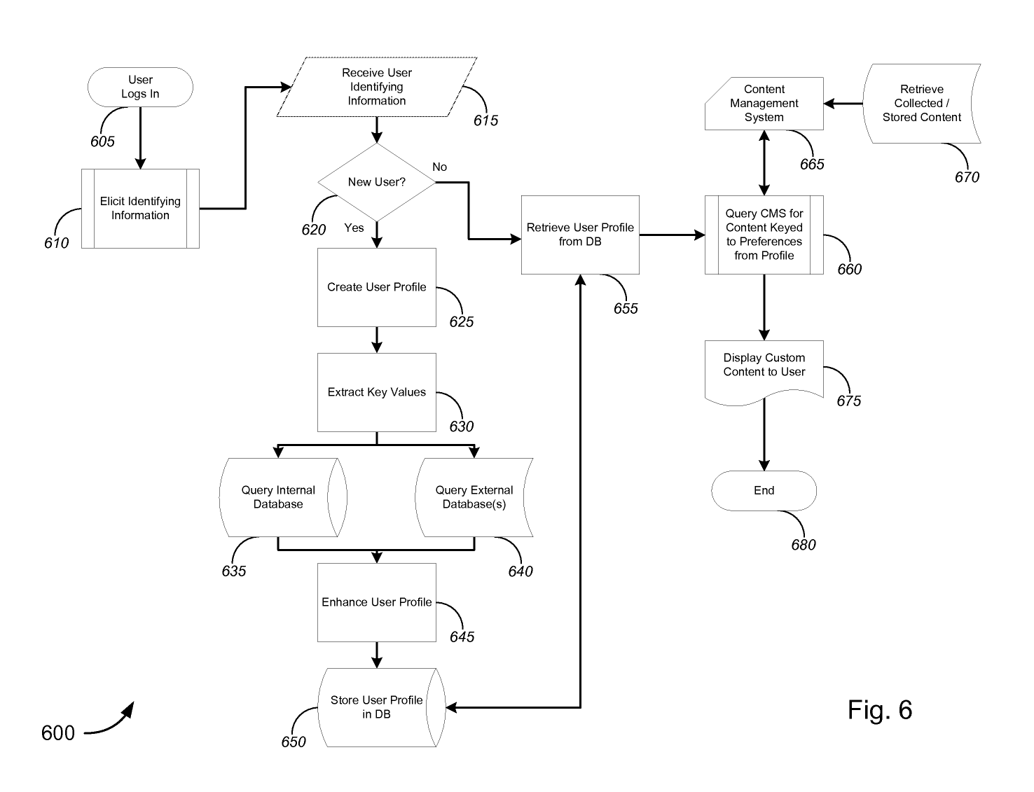

A method of determining a user's preference profile is illustrated by FIG. 5. This method can take into account any combination of the factors or values described herein. In an aspect, the method can ensure that the system obtains the maximum available amount of disambiguation given that the user can terminate the process at an arbitrary point. FIG. 6 illustrates a method of personalizing housing-preference-relevant content. This method can take into account any combination of the factors or values described herein.

(1) Determining of a User's Preference Profile

In order to effectively find products that meet a user's needs, it is necessary to understand a user's needs. While it is theoretically possible to establish a user's needs by simply asking them, for complex products that have a large plurality of characteristic dimensions, it is impractical to ask users for their preferences along each dimension, and how they rank order criteria and make tradeoffs among them. Asking such extensive questions would be tedious for the user, and may result in abandonment of the profiling survey before completion; moreover, users often do not explicitly or accurately describe their tradeoff functions when asked.

Fortunately, people tend to have cross-correlations in their preferences, and these cross-correlations may be used by market researchers to group users as “segments.” Segment membership tends to correspond to demographic, psychographic, and/or behavioral factors not necessarily explicitly related to their product preferences (“key values”). Market researchers can ask a sample of people for extensive preference information, and/or use techniques such as orthogonal survey instrument design to ask people for subsets of their preferences, and use the gathered data to construct segment profiles that are projectable with reasonable statistical confidence to non-surveyed individuals using key values.

In some instances, analysis of key values may reduce the number of potential segments to which users may belong, but such key value analysis may not be determinative of membership in a single segment with sufficient confidence, and may indicate probable membership in a plurality of segments. When this is the case, it is possible to disambiguate segment membership by explicitly or implicitly prompting the user for information that indicates membership in one segment and not another. For instance, if a user is likely a member of Segment A or Segment B or Segment C (but not D, E, or F, etc.), and the key value analysis doesn't indicate which, and if members of Segment A like to take foreign vacations while members of Segment B prefer to go to domestic theme parks for vacations, and members of Segment C prefer to go camping on vacations, one may ask the user to choose a preferred vacation destination from among those categories of choices using a survey instrument or some other means of data acquisition.

When multiple segment membership is possible, it may be that certain data are of greater discriminatory power than other data; for example, to take the above instance, if vacation preferences for camping versus theme parks is not as clearly discriminative between Segment A and Segment C as desired, but the kind of primary vehicle the user drives could provide the level of confidence desired (and also provide the required level of certainty regarding membership in Segment B), it is desirable to acquire car use, rather than vacation preference data about the user. In some instances, no single dimension will provide sufficient discrimination between multiple segments; in these cases, additional data may be elicited from the user in order of decreasing discriminatory power, such that the total number of disambiguation steps to which the user is subjected is minimized.

As a given individual continues to use such a system over time, the system can use information about the user's behavior to adjust the relative importance of each dimension embodied by a property. In this way, the system's performance with respect to the user will likely improve over time. Furthermore, when multiple users who are members of a potential future residential social unit (e.g., a family) use the system, the system can optimize for the union of preferences of all of the users at once. Additionally and/or alternatively, the system can use user behavior to adjust its initial estimates of the relative importance of each dimension over time, on a cross-user basis. These initial estimates may be adjusted for each demographic, each locality, or globally.

In some aspects, a method of producing a new preference profile for a user might comprise combining multiple measures of user preferences across a multiplicity of dimensions (e.g., preference for adventure vacations, granite counters in kitchens, luxury sports cars, etc.). In some embodiments, making a component profile might include using data from a demographic segment known to match some or all known characteristics of the user. In some instances, making a component profile might include using data about the user's preferences that are available as a natural result of the user using an online service, including, but not limited to, how long the user looks at pictures of contrasting items related to a given dimension (e.g., luxury sailboats versus luxury cars), which questions the user chooses to answer from a panel of options, how quickly the user answers a given prompt, etc. In some cases, making a component profile might include importing relevant data from external sources of information about the user, including, without limitation, credit card bills, email correspondence, electronic address books, etc. According to some embodiments, making a component profile might include explicitly asking the user about his preferences in a specific candidate dimension (e.g., asking, “How important are luxury sink faucets to you?”) and using the user's response to the question as a dimension of the component profile. In some cases, the candidate dimension in question might be chosen by analyzing the discriminatory power of each possible known candidate dimension, and choosing the dimension thereby revealed to have the most discriminatory power.

According to some embodiments, a multiplicity of component profiles may be used, each of which might be any of the aspects or embodiments described above, or any combination thereof. In some instances, wherein the process might be iterative, and might include adding dimensions to the model until such a point as the model is judged to have sufficient discriminatory power for the purposes at hand.

(2) Personalizing Housing-Preference-Relevant Content in a User's Preference Profile

Residential real estate shoppers have diverse sets of needs for features in prospective housing. By using information provided by shoppers and/or third parties about them, an understanding of those needs sets can be developed and used to tailor content intended for their use in assessing properties for purchase and/or rent.

Needs profiles are developed by using identifying information on a prospective buyer which may comprise, without limitation, their name, place of residence, telephone number, and/or e-mail address. This information may be supplemented with information concerning housing preferences directly or indirectly elicited from the shopper, but even without information sourced directly from the shopper, the system can develop a needs profile, using only identifying information as key values for looking them up on first, third, or related-party databases, and/or determining their similarity to persons in those databases, which contain information relating to their housing needs or information concerning their lifestyle, transaction patterns, demographics, location, psychographics, and/or other information from which their housing needs can be inferred. The needs profile for a user may be modified on an ongoing basis, and may include information from sales agents who have interacted with the user in any way (e.g., via phone, email, and/or in person, etc.). In this way, the profile may grow more accurate over time.

Housing needs profiles might include, without limitation, requirements or preferences for type of housing (e.g., single family home, large multi-unit condominium, townhouse, etc.), construction of building (e.g., wood frame, steel and concrete, etc.), number of bedrooms/bathrooms/other room types, square footage of home, square footage of lot, fittings and finishes, appliances, on-property amenities (e.g., pool, garden, etc.), type of deed or lease agreement, financing availability, neighborhood character, architecture/style of residence, density of neighborhood, school quality, access to transit, access to shopping, proximity to parks, proximity to entertainment, ease of shopping, types of nearby commercial establishments, trend in resale value of comparable housing, trend in neighborhood demographics, nearby development activity, etc.

Once a needs profile has been developed for a shopper, the system can automatically serve content to the shopper that highlights features of the property and/or its surroundings that are pertinent to that shopper's needs. For instance, if the shopper has a propensity to entertain at home and enjoys gourmet cooking, the system will display or highlight features of the home under consideration that make it suitable for entertaining and facilitating the cooking of gourmet meals. Furthermore, for instance, the system may automatically display a map highlighting nearby places to buy gourmet ingredients. Service of content can take place over a plurality of electronically mediated communications systems including, without limitation, web pages, electronic mail, social media, mobile application, or custom-generated physical collateral.

In some aspects, a method might comprise using a plurality of endogenous and/or exogenous factors to determine the needs profile for a prospective user. According to some embodiments, factors from which the needs profile is generated might include, without limitation, personal data about the user and/or the user's family, self-reported personal data about the user and/or the user's family, personal data about the user and/or the user's family which has been collected from first or third party agents (including, without limitation, sales agents, or the like), personal data about the user and/or the user's family which has been obtained from databases collecting the personal data of individuals, a measure of similarity of the user with other users, and/or the like.

The measure of similarity of the user with other users, according to some embodiments, might include a measure of Euclidean distance in parameter space, or other mathematical relationship between the data elements in database records corresponding to individual users or groups of users. In some cases, the profile associated with one or more of the similar users might contain information that relates to the needs profile of those similar users.

According to some embodiments, the needs profile developed might contain information including, but not limited to, information related to the requirements of the user related to housing; information related to the conscious and/or stated preferences of the user in question; information related to the preferences of the user in question of which the user is not consciously aware; information related to the preferences of the user in question for the type of building in question; information related to the preferences of the user in question for the construction of the residence in question; information related to the preferences of the user in question for the types, sizes, and numbers of rooms in the residence in question; information related to the preferences of the user in question for the financing details of a real estate transaction involving a residence; information related to the preferences of the user in question for style furnishings, fittings, and/or appliances, high-quality locks, security windows, etc.; information related to the preferences of the user in question for on-site amenities; information related to the preferences of the user in question for neighborhood character; information related to the preferences of the user in question for characteristics of schools in the neighborhood; information related to the preferences of the user in question for characteristics of public schools in the neighborhood; information related to the preferences of the user in question for characteristics of private schools in the neighborhood; information related to the preferences of the user in question for trends in resale value of comparable housing; information related to the preferences of the user in question for trends in demographics of neighborhood residents; information related to the preferences of the user in question for trends relating to reported crime in the neighborhood; and/or the like.

In some cases, information related to the preferences of the user in question for the type of building in question might include, without limitation, standalone home, townhouse, unit in a building with fewer than twenty units, unit in a large condominium or apartment building, etc. Information related to the preferences of the user in question for the construction of the residence in question might include, without limitation, steel frame, wood frame, concrete, etc. Information related to the preferences of the user in question for the types, sizes, and numbers of rooms in the residence in question might include, without limitation, the number of bedrooms, the sizes of bedrooms, the number of bathrooms, the presence of a den or study, etc. Information related to the preferences of the user in question for the financing details of a real estate transaction involving a residence might include, without limitation, details about the mortgage.

Details about the mortgage might include length of mortgage, type of mortgage (adjustable, partial adjustable, fixed, etc.), relevant interest rate or rates, etc. Style furnishings, fittings, and/or appliances might include, without limitation, architectural style of the residence or building, presence or absence of dishwashers, washing machine, dryer, etc. On-site amenities might include, without limitation, the presence or absence of a swimming pool, hot tub, garden, gym, etc. Neighborhood character might include, without limitation, the presence or absence of specific types of businesses or zoning within given distances or distance ranges from the residence, the maintenance level of nearby streets and sidewalks, the presence or absence of specific types of law enforcement activity in the neighborhood, density of residential units in the neighborhood, architectural style prevalent in the neighborhood, proximity to parks, playgrounds, shopping, public transit, etc.

In some embodiments, a method might comprise using a plurality of endogenous and/or exogenous factors to determine the representation of a property or neighborhood profile for the purposes of display to a user (including, a potential homeowner, a potential renter, or a sales/rental agent). In some instances, the representation developed might contain information including, without limitation, information related to a needs profile of a user; information related to the needs profile of a user who is a potential resident and/or purchaser of the property or neighborhood in question; and/or the like. In some cases, the representation developed might be intended for display to a sales or rental agent for the purposes of assessing the suitability of the property or neighborhood for a specific other person who may become a resident and/or purchaser of the property or resident of the neighborhood in question.

According to some embodiments, the needs profile in question might be developed in accordance with any of the above aspects or embodiments. The representation in question might emphasize elements of the property or neighborhood which are indicated as important by the needs profile in question. In some cases, the representation in question might deemphasize or eliminate display relating to elements of the property or neighborhood which are indicated as unimportant or adverse to the user's interests by the needs profile in question.

### Exemplary Embodiments

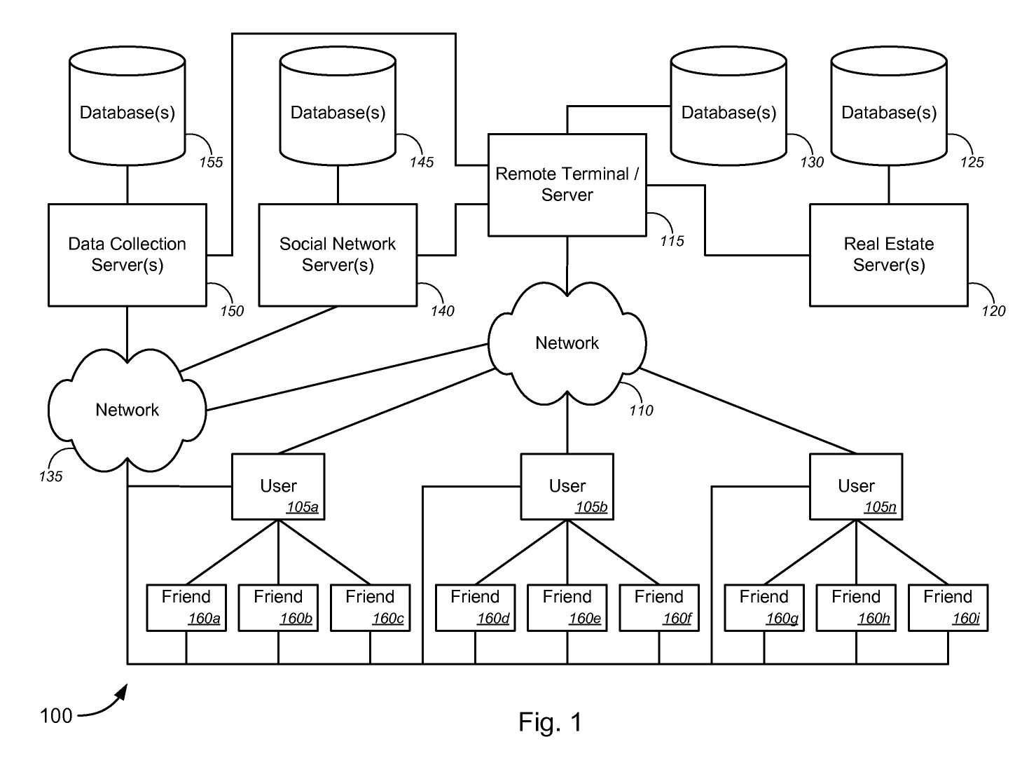

FIGS. 1-8 illustrate some of the features of the method, system, and apparatus for determining suitability and/or desirability of a prospective residence for a user, as referred to above. The methods, systems, and apparatuses illustrated by FIGS. 1-8 refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

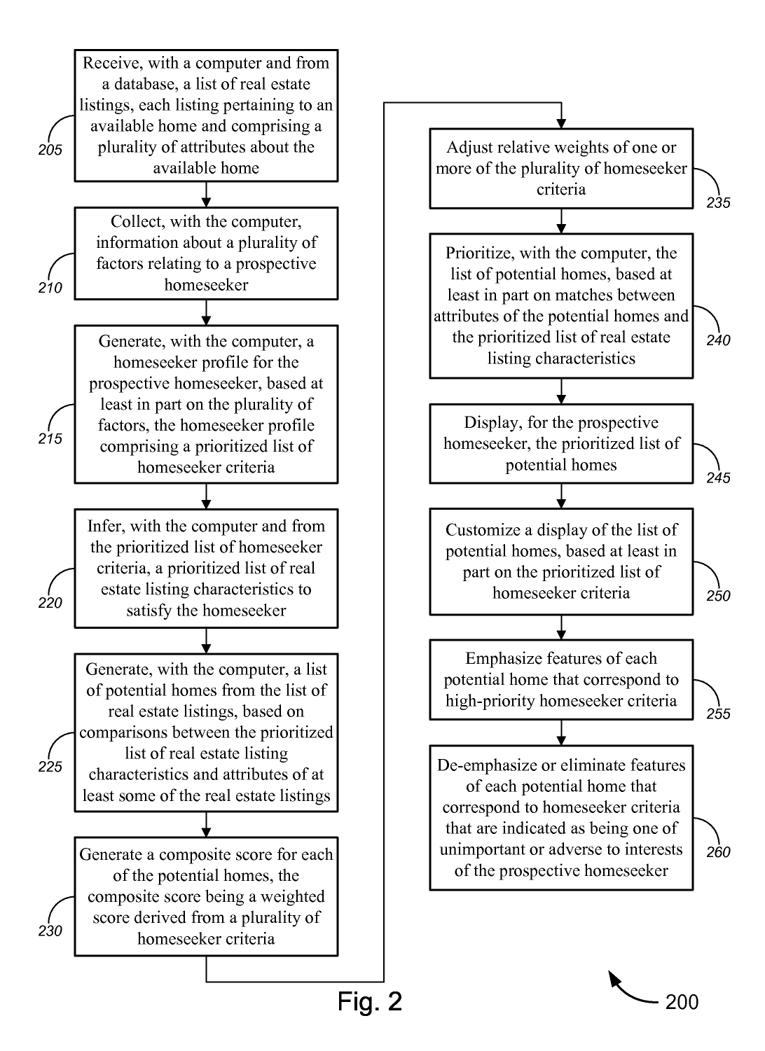

FIG. 1 is a general schematic diagram illustrating a system 100 for determining suitability and/or desirability of a prospective residence for a user, in accordance with various embodiments. While the system described below with respect to FIG. 1 are described with respect to implementing methods for determining suitability and/or desirability of a prospective residence for a user, as shown and described in detail with respect to FIGS. 2-4 and 6, the system of FIG. 1 may be similarly applicable to implementing methods for determining user's preference profiles in general, as shown and described in detail with respect to FIG. 5. Further, while system 100 can operate according to the methods illustrated by FIGS. 2-6, system 100 can also operate according to other modes of operation and/or perform other suitable procedures. It should be further noted that although a particular configuration of system 100 is shown in FIG. 1, any appropriate configuration may be implemented without deviating from the scope of the various embodiments.

In FIG. 1, system 100 might comprise a plurality of users 105a-105n (collectively, “users 105”), or more particularly, one or more user devices associated with each of the plurality of users. The one or more user devices might comprise one or more of at least one desktop computer, at least one laptop computer, at least one tablet computer, at least one smart phone, at least one mobile phone, or at least one portable gaming device, and/or the like. System 100 might further comprise network 110 and a remote terminal or server 115. A user 105 among the plurality of users 105 might access, via network 110, a user interface (“UI”) hosted by the server 115. In some embodiments, the UI might comprise a graphical user interface (“GUI”).

In the various embodiments, the user might be a homeseeker, either a potential home buyer or potential home renter. Accordingly, the various examples below are described from the perspective of facilitating search of a home for purchase or rent/lease by a homeseeker. The various embodiments, however, are not so limited, and any similar application of system 100 for non-home-related applications may be implemented without deviating from the scope of the invention.

In the embodiment of FIG. 1, a homeseeker 105 might access, via network 110, a homeseeker search UI hosted by server 115. In some embodiments, server 115 might communicate with one or more real estate servers 120, in order to access real estate listings compiled and/or stored on one or more databases 125. In alternative embodiments, server 115 might directly access real estate listings compiled and/or stored on the one or more databases 125. Each listing might pertain to an available home and might comprise a plurality of attributes about the available home. In still other embodiments, at least one of the one or more real estate servers 120 and/or at least one of the one or more databases 125 might be part of, or otherwise incorporated within, server 115 and/or at least one of one or more databases 130.

A more detailed description of attributes and types of attributes of homes is provided above. Examples of attributes might include, but are not limited to, an estimated total monthly cost of the available home; an estimated total cost of ownership of the available home; nearby schools and information about these schools; proximity to public transit access; proximity to freeway access; proximity to shopping, dining, exercise, recreation, or other convenience or avocational facilities; proximity to homeseeker's workplace or vocational facilities; location of the property within a specific geographical, geological, political, and/or historical area; location of the property proximate to people associated with the homeseeker (e.g., family members/relatives, friends, co-workers, former/current classmates, enemies, frenemies, social media “friend,” acquaintance, and/or the like) or to people the homeseeker likes/admires or dislikes/hates (e.g., celebrities, politicians, etc.); features of the home or property; features and/or reputation of the neighborhood to which the property belongs; and/or the like.

Features of the home or property, as described in detail above, might include, without limitation, number, size, and/or arrangement of bedrooms; number, size, and/or arrangement of bathrooms; size and layout of other living area(s); presence or absence of guest houses, housekeeper quarters, children's wings, entertainment rooms, indoor/outdoor pool(s), and/or the like; presence or absence of attached/detached garage(s) and the size of the garage(s); features of the lot on which the home is built (including, but not limited to grade, presence or absence of water, etc.); presence or absence of specific landscaping features (e.g., trees over a certain height, a waterfall, other water features, forest path, outdoor kitchen, patio/deck, etc.); architectural style including types of construction materials used, presence or absence of specific architectural or aesthetic features (e.g., vintage moldings, tall ceilings, vaulted ceilings, floor-to-ceiling windows, skylights, etc.); degree of privacy available on the property; views available from the property; susceptibility of the residence or related improvements to natural forces or man-made activities; value of property and tax relevant considerations;

According to some embodiments, server 115 might generate a homeseeker profile for the prospective homeseeker 105, and might store the homeseeker profile in database(s) 130, which is communicatively coupled to server 115, and which is either internal and/or external to server 115.

In an aspect, server 115 might collect information about a plurality of factors relating to homeseeker 105, which are described in detail above. Examples of factors might include, without limitation, a location of a likely frequent destination of the prospective homeseeker, a history of prior residences of the prospective homeseeker, information obtained from a social networking account of the potential homeseeker, information indicative of user preferences of the homeseeker across a multiplicity of dimensions comprising home-related dimensions and non-home-related dimensions, information about locations of a plurality of associates of the homeseeker, and/or the like. Herein, as described above, non-home-related dimensions might include dimensions reflecting user preferences, which might include, without limitation, user preferences for types of cars, user preferences for types of food and/or drinks, user preferences for vacation destinations and/or types of vacations (e.g., relaxing vacations, adventure vacations, undersea vacations, cruise vacations, beach vacations, safari vacations, space adventure vacations, rainforest vacations, third world vacations, popular tourist destination vacations, and/or the like), user preferences for types of home appliances and/or furnishes (including, e.g., preferences for kitchen granite counters, sofas, dining tables, bedroom furnishings, and/or the like), user preferences for professional sports teams and/or players, user preferences for consumer electronics, user preferences for multi-media content, and/or the like.

In some embodiments, such factors of the user or homeseeker 105 might be derived from self-reported information about the user or homeseeker 105, provided by the user or homeseeker 105, over network 135, to one or more social network servers 140, which might operate social media websites. Such servers 140 might store the self-reported information in one or more databases 145. In some cases, the information about the user or homeseeker 105 might be provided to the one or more social network servers 140 by friends, family members, enemies, frenemies, and/or the like who are associated with the user or homeseeker 105.

Merely by way of example, in some instances, the homeseeker's 105 online activities might be monitored (either known or unbeknownst to homeseeker 105) by one or more data collection servers 150, which might store such collected information about the homeseeker 105 in one or more databases 155. Some examples of monitoring the homeseeker's 105 online activities might include, without limitation, monitoring websites visited by homeseeker 105, monitoring content (including images, videos, music, documents, etc.) accessed, viewed, downloaded, and/or shared by homeseeker 105 (including how long homeseeker 105 looks at the images and videos, reads the documents, or listens to the music, etc.), monitoring purchases made by homeseeker 105, monitoring services subscribed to by homeseeker 105, monitoring persons or organizations with whom homeseeker 105 associates, monitoring survey questions answered by homeseeker 105 (as well as the corresponding answers provided by homeseeker 105 and relevant response times, etc.), and/or the like.

In some embodiments, in generating the homeseeker profile for the prospective homeseeker 105, server 115 might collect the information about the plurality of factors relating to the prospective homeseeker 105 from the one or more social network servers 140 and/or the one or more data collection servers 150, either directly or indirectly via networks 110 and 135 (which in some cases might be different networks, while in other cases might be the same network). In some instances, server 115 might collect the information about the plurality of factors relating to the prospective homeseeker at least in part by directly from homeseeker 105 via network 110.

According to some embodiments, in generating the homeseeker profile, server 115 might collect information about a plurality of associates 160 of the homeseeker 105, which associates 160 might include, without limitation, family members/relatives, friends, co-workers, former/current classmates, enemies, frenemies, social media “friend,” acquaintance, and/or the like (collectively, “friends”), who might be mutually-declared friends (i.e., where each has designated the other as a friend) or unilaterally-declared friends (i.e., where only one of the parties has designated the other as a friend). In some cases, the location, preferences, and relation with the homeseeker 105 of the friend 160 (which might include friends 160a-160i or more) might influence the decision of the homeseeker 105 (whether positively or negatively) with respect to one or more particular potential homes listed in received real estate listings. Such information about the one or more friends 160 might be collected, by the server 115, from the one or more social network servers 140 and/or the one or more data collection servers 150, in a manner similar to that for information about the plurality of factors relating to the prospective homeseeker 105 that is described above.

In some cases, although three friends 160 are shown for each user 105, this is merely for illustration purposes, and any number of friends of each user may be monitored by the system and/or otherwise considered by server 115 for determining suitability and/or desirability of a prospective residence for a user. Further, although FIG. 1 shows friends of each user being different from friends of the other users, the various embodiments are not so limited, and friends 160a-160c of user 105a might overlap with one or more of friends 160d-160f of user 105b and/or one or more of friends 160g-160i of user 105n, and/or the like.

We now turn to FIG. 2, which is a general schematic flow diagram illustrating a method 200 for determining suitability and/or desirability of a prospective residence for a user, in accordance with various embodiments. While the techniques and procedures are depicted in FIG. 2 in a certain order for purposes of illustration, it should be appreciated that certain procedures may be reordered and/or omitted within the scope of various embodiments, and that various embodiments might comprise only portions of the illustrated method, each of which can be considered methods in their own right. Moreover, while the method illustrated by FIG. 2 can be implemented by a computer system (such as the systems described in further detail below), these methods may also be implemented using any suitable hardware implementation. Similarly, while the systems described herein (and/or components thereof)—such as systems 100, 700, and 800 shown in FIGS. 1, 7, and 8, respective—can operate according to the method illustrated by FIG. 2 (e.g., by executing instructions embodied on a computer readable medium), the systems 100, 700, and 800 can also operate according to other modes of operation and/or perform other suitable procedures. It should be further noted that the method illustrated by FIG. 2 (and/or various operations thereof) can be combined with methods disclosed in the Related Applications (and/or various operations thereof) to provide various functionality in accordance with different embodiments.

In the embodiment of FIG. 2, method 200 might comprise receiving, with a computer and from a database (e.g., server 115 and database(s) 125, respectively shown in FIG. 1), a list of real estate listings (block 205). Each listing might pertain to an available home and might comprise a plurality of attributes about the available home. Method 200 might further comprise, at block 210, collecting, with the computer, information about a plurality of factors relating to a prospective homeseeker (such as homeseeker 105 shown in, and described above with respect to, FIG. 1).

At block 215, method 200 might comprise generating, with the computer, a homeseeker profile for the prospective homeseeker, based at least in part on the plurality of factors. The homeseeker profile might comprise a prioritized list of homeseeker criteria. In some embodiments, generating the homeseeker profile might comprise analyzing a psychographic and/or behavioral relationship between one or more of the plurality of factors and one or more of the homeseeker criteria. In some instances, generating the homeseeker profile might comprise generating the homeseeker profile using at least in part data from a demographic and/or behavioral segment of a population group known to match at least some known characteristics of the homeseeker (the segment being described in detail above and also with respect to FIG. 5 below). In some cases, generating the homeseeker profile might comprise estimating demand for one or more features of available homes based on aggregate behavior of a plurality of homeseekers other than the prospective homeseeker. According to some embodiments, the prospective homeseeker might have a relationship (whether bilateral or unilateral) with each of the plurality of homeseekers other than the prospective homeseeker, while in other embodiments, the prospective homeseeker might have no relationship with one, more, or all of the plurality of homeseekers other than the prospective homeseeker.

In some embodiments, generating the homeseeker profile might comprise collecting information about a plurality of factors relating to each of a plurality of individuals within a single household. Collecting information about a plurality of factors, in some instances, might comprise collecting, from one or more of the plurality of individuals within the single household, self-reported personal data about one or more individuals of the plurality of individuals within the single household. In some cases, collecting information about a plurality of factors might comprise collecting—from one or more of business, social media sources, or other on-line sources—information indicative of personal preferences and demographic information about one or more individuals of the plurality of individuals within the single household, as a result of one or more of business activities, social media activities, or other on-line activities of the one or more individuals within the household. Other methods of generating the homeseeker profile (or user preference profile or similar profile) are described in detail throughout this disclosure and in the Related Applications.

Method 200 might further comprise inferring, with the computer and from the prioritized list of homeseeker criteria, a prioritized list of real estate listing characteristics to satisfy the homeseeker (block 220) and generating, with the computer, a list of potential homes from the list of real estate listings, based on comparisons between the prioritized list of real estate listing characteristics and attributes of at least some of the real estate listings (block 225).

At block 230, method 200 might comprise generating a composite score for each of the potential homes. The composite score might be a weighted score derived from a plurality of homeseeker criteria. Method 200, at block 235, might comprise adjusting relative weights of one or more of the plurality of homeseeker criteria, e.g., by using a learning algorithm or other suitable methods of refining weights based on acquisition of additional data and/or performing additional analysis, to enhance prospective homeseeker satisfaction with the displayed list of potential homes. Such other suitable methods might, for example, include, without limitation, asking a particular user if a number of bathrooms should be made more important in the ranking for him or her. Method 200 might further comprise prioritizing, with the computer, the list of potential homes, based at least in part on matches between attributes of the potential homes and the prioritized list of real estate listing characteristics (block 240). In some embodiments, matches need not be exact; rather, closeness of a match to a target value may be a factor. In some cases, the criteria and/or attributes may have different weights.

At block 245, method 200 might comprise displaying, for the prospective homeseeker, the prioritized list of potential homes. In some embodiments, method 200, at block 250, might comprise customizing a display of the list of potential homes, based at least in part on the prioritized list of homeseeker criteria. Customizing the display of the list of potential homes might comprise emphasizing features of each potential home that correspond to high-priority homeseeker criteria (block 255), one of de-emphasizing or eliminating features of each potential home that correspond to homeseeker criteria that are indicated as being one of unimportant or adverse to interests of the prospective homeseeker (block 260), or both.

Homeseeker Search Tools and Techniques:

FIG. 3 is a process flow diagram illustrating a method 300 of determining the suitability of a prospective residence, in accordance with various embodiments. FIG. 4 is a process flow diagram illustrating a method 400 of determining the desirability of a prospective residence for a user, in accordance with various embodiments. While the techniques and procedures are depicted in FIGS. 3 and 4 in a certain order for purposes of illustration, it should be appreciated that certain procedures may be reordered and/or omitted within the scope of various embodiments, and that various embodiments might comprise only portions of the illustrated method, each of which can be considered methods in their own right. Moreover, while the methods illustrated by FIGS. 3 and 4 can be implemented by a computer system (such as the systems described in further detail below), these methods may also be implemented using any suitable hardware implementation. Similarly, while the systems described herein (and/or components thereof)—such as systems 100, 700, and 800 shown in FIGS. 1, 7, and 8, respective—can operate according to the methods illustrated by FIGS. 3 and 4 (e.g., by executing instructions embodied on a computer readable medium), the systems 100, 700, and 800 can also operate according to other modes of operation and/or perform other suitable procedures. It should be further noted that the methods illustrated by FIGS. 3 and 4 (and/or various operations thereof) can be combined with methods disclosed in the Related Applications (and/or various operations thereof) to provide various functionality in accordance with different embodiments.

In the embodiment of FIG. 3, a home search by a user or homeseeker (e.g., user or homeseeker 105 in FIG. 1) might begin at block 304 of method 300. At block 308, method 300 might comprise developing or acquiring the user's initial preference profile. Method 300 might further comprise eliciting direct preference element expressions (block 312) and/or eliciting key values for indirect preference lookup (block 316). Following block 316, method 300 might comprise, at block 320, acquiring inferred preference profile elements using key values, from database of block 368 (which include database(s) 130 in FIG. 1 for friends 160 of homeseeker 105). Thereafter, following either block 312 and/or block 320, method 300 might further comprise creating a fully dimensioned initial user preference profile (which, as described in detail above, includes a full profile of the user including both home-related dimensions and non-home-related dimensions), at block 324.

At block 328, method 300 might further comprise storing the user preference profile in a database (e.g., database(s) 130 in FIG. 1). Method 300, at block 332, might comprise comparing the profile to available home stock and, at block 336, might retrieve the home data (which may be fully dimensioned and might be retrieved, e.g., from database(s) 125 in FIG. 1). Method 300 might further comprise calculating similarity(ies) of each profile dimension to home characteristics (block 340) and adjusting a similarity score by weighting for profile tradeoff function (block 344).

At block 348, method 300 might comprise ranking order matches, and might further comprise, at block 352, displaying an ordered list to the user. In some embodiments, displaying the ordered list to the user might include displaying to one or more user devices associated with the user; the one or more user devices might include, without limitation, at least one desktop computer, at least one laptop computer, at least one tablet computer, at least one smart phone, at least one mobile phone, or at least one portable gaming device, and/or the like. Method 300 might, at block 356, comprise recording behavior versus matches as an indication of match quality. Method 300 might further comprise recalculating preference profile using match quality feedback (block 360), and the recalculated preference profile may be stored in the user preference profile (returning to block 328). In some embodiments, method 300 might further comprise, following block 360, recalculating cohort preference profile estimates (block 364), storing cohort-based preference profile estimate data (block 368), and including the cohort-based preference profile estimate data in the inferred preference profile elements that are acquired at block 320.

Method 300 might further comprise, at block 372, re-ranking the results, which might be based at least in part on the recalculated preference profile from block 360. A determination may then be made, at block 376, as to whether the user returns to the results listings. If not, the method 300 ends (block 388). If so, the method 300, at block 380, comprises displaying the re-ordered list to the user (in a manner similar to displaying the ordered list in block 352). At block 384, a determination may be made as to whether the user concludes the search. If not, the process returns to block 356. If so, the process ends, at block 388.

Turning to FIG. 4, method 400 might comprise, at block 405, starting the process (perhaps with a known user, a known prospective housing location, or both). At block 410, method 400 might comprise prompting the user or homeseeker (e.g., user or homeseeker 105 in FIG. 1) for social graph access and/or key values to obtain a social graph. Herein, “social graph” might refer to a graph that shows personal relationships of a user, and in some cases, shows some, most, or all known, or publicly available information about, relationships of the user on the Internet and/or other publicly accessing sources/databases. In some aspects, the user's social graph may include at least some information about the personal relationships of the user accessible through some subscription-based services, including, e.g., social media services or the like. The social graph, in some instances, might be a graphical or relational representation of the user's social network. Method 400 might further comprise acquiring the user's social graph (block 415), e.g., by accessing a database(s) (e.g., database(s) 145 and/or 155 in FIG. 1) that is(are) operated or maintained by one or more social graph providers (block 420).

Method 400 might comprise, at block 425, scoring each friend for nature/quality of social connection (social proximity score) and, at block 430, eliminating friends below relevance threshold values. At block 435, method 400 might comprise acquiring the user's social graph-relevant member geo-location (otherwise referred to as “geolocation”) data, e.g., by accessing a database(s) (e.g., database(s) 145 and/or 155 in FIG. 1) that is(are) operated or maintained by one or more geo-location data providers (block 440). Method 400, at block 445, might comprise calculating distances and/or travel times for each friend's geo-locations. At block 450, method 400 might comprise weighting each friend's geo-locations for frequency and recency of visitation, and nature of the venue.

Method 400 might further comprise applying social proximity score weightings to weighted geo-locations (block 455). Method 400 might end by providing an additive score that is the prospective home's social desirability score (block 460).

User Profile Tools and Techniques:

FIG. 5 is a process flow diagram illustrating a method 500 of determining a user's preference profile, in accordance with various embodiments. FIG. 6 is a process flow diagram illustrating a method 600 of personalizing housing-preference-relevant content, in accordance with various embodiments. While the techniques and procedures are depicted in FIGS. 5 and 6 in a certain order for purposes of illustration, it should be appreciated that certain procedures may be reordered and/or omitted within the scope of various embodiments, and that various embodiments might comprise only portions of the illustrated method, each of which can be considered methods in their own right. Moreover, while the methods illustrated by FIGS. 5 and 6 can be implemented by a computer system (such as the systems described in further detail below), these methods may also be implemented using any suitable hardware implementation. Similarly, while the systems described herein (and/or components thereof)—such as systems 100, 700, and 800 shown in FIGS. 1, 7, and 8, respective—can operate according to the methods illustrated by FIGS. 5 and 6 (e.g., by executing instructions embodied on a computer readable medium), the systems 100, 700, and 800 can also operate according to other modes of operation and/or perform other suitable procedures. It should be further noted that the methods illustrated by FIGS. 5 and 6 (and/or various operations thereof) can be combined with methods disclosed in the Related Applications (and/or various operations thereof) to provide various functionality in accordance with different embodiments.

When determining a user's preference profile, it is sometimes necessary to determine whether a user belongs to (or otherwise has membership) to multiple “segments.” Herein, “segments” might refer to groupings of users by market researchers or the like. Segment membership might correspond to demographic, psychographic, and/or behavioral factors that are not necessarily explicitly related to the users' product preferences (“key values”).

In the embodiment of FIG. 5, method 500 might comprise eliciting key values (block 505). At block 510, method 500 might comprise looking up segment membership using key values, e.g., by accessing one or more segmentation databases (block 515). A determination may then be made, at block 520, as to how many segments correspond to key values. If it is determined that there is only one segment corresponding to key values, the process ends (at block 545). If it is determined, however, that there is more than one (i.e., >1) segment corresponding to key values, the process proceeds to block 525, at which a disambiguation function is implemented. At block 530, method 500 might comprise determining the most discriminatory disambiguation data. Method 500, at block 535, might comprise eliciting the disambiguation data.

According to some embodiments, the disambiguation function might seek to determine preferences of members of the segments in order to determine the most discriminatory disambiguation data. For example, if members of Segment A are known to enjoy taking foreign vacations while members of Segment B prefer to go to domestic theme parks for vacations, and members of Segment C prefer to go camping on vacations, the most discriminatory disambiguation data might be preferred vacation destinations, and such information may be elicited from the user. In some other cases, the discriminatory disambiguation data having greater discriminatory power might be preferred type of primary vehicle driven by the users, while in yet other cases, the discriminatory disambiguation data having greater discriminatory power might include one or more of preferred airline, preferred supermarket, preferred smart phone, and/or the like. In some instances, no single dimension will provide sufficient discrimination between multiple segments; in such cases, additional data may be elicited from the user in order of decreasing discriminatory power, such that the total number of disambiguation steps to which the user is subjected is minimized.

A further determination may be made as to how many segments correspond to key values and disambiguation data (block 540). If it is determined that there is more than one (i.e., >1) segment corresponding to key values and disambiguation data, then the process returns to block 525. On the other hand, if it is determined that there is only one segment corresponding to key values and disambiguation data, the process ends at block 545.

The information about the user that is obtained in method 500 may be used to generate and/or update a user's preference profile, which may subsequently be used to facilitate the user's search of homes and/or for other services for the user.

Turning to the embodiment shown in FIG. 6, method 600 might begin at block 605 with a user or homeseeker (e.g., user or homeseeker 105 in FIG. 1) logging in to a UI (e.g., a UI hosted by server 115 in FIG. 1, or the like). At block 610, method 600 might comprise eliciting identifying information, and receiving the user identifying information (block 615). A determination may be made, at block 620, as to whether the user is a new user. If not, the process proceeds to block 655.

If so, the process proceeds to block 625, at which a user profile is created for the new user. Method 600 might further comprise extracting key values (block 630), and might also comprise querying one or more internal databases (e.g., database(s) 130 in FIG. 1) (block 635) and/or querying one or more external databases (e.g., database(s) 145 and/or 155 in FIG. 1) (block 640). At block 645, method 600 might comprise enhancing the user profile 645, in light of results from the queries. Method 600 might further comprise, at block 650, storing the user profile in a database (e.g., database 130 shown in FIG. 1).

The process might then proceed to block 655 (which is applicable to both new and known users), at which method 600 might comprise retrieving the user profile from the database. At block 660, method 600 might comprise querying a content management system (“CMS”) for content keyed to preferences from the user profile. At block 665, the CMS is queried, and the content might be retrieved from a content database by the CMS (at block 670). In some embodiments, the content might be pre-collected or pre-stored (i.e., prior to CMS being queried), while, in some instances, the content might be collected and stored in response to the CMS being queried and the CMS querying the content database. Method 600 might, at block 675, display the custom content to the user (in a manner not unlike that in blocks 352 and 380 of FIG. 3). The process might end at block 680.

Exemplary Hardware:

While the techniques and procedures are described above in a particular order for purposes of illustration, it should be appreciated that certain procedures may be reordered and/or omitted within the scope of various embodiments, and that various embodiments might comprise only portions of one or more methods, of which the portions (and/or combinations thereof) can be considered methods in their own right. Moreover, while the methods described above and in the Related Applications can be implemented by a computer system (such as the systems described in further detail below), these methods may also be implemented using any suitable hardware implementation. Similarly, while the systems described below (and/or components thereof) can operate according to the described methods (e.g., by executing instructions embodied on a computer readable medium), such systems can also operate according to other modes of operation and/or perform other suitable procedures. It should be further noted that the described methods (and/or various operations thereof) can be combined with each other and/or with methods disclosed in the Related Applications (and/or various operations thereof) to provide various functionality in accordance with different embodiments.

In an aspect, the system provides a user interface (and various methods can include providing a user interface), which allows users to interact with the computer system. A variety of user interfaces may be provided in accordance with various embodiments, including, without limitation, graphical user interfaces that display, for a user, display screens for providing information to the user and/or receiving user input from a user.

Merely by way of example, in some embodiments, the system may be configured to communicate with a client computer via a dedicated application running on the client computer; in this situation, the user interface might be displayed by the client computer, based on data and/or instructions provided by the computer system. In this situation, providing the user interface might comprise providing instructions and/or data to cause the client computer to display the user interface. In other embodiments, the user interface may be provided from a web site, e.g., by providing a set of one or more web pages, which might be displayed in a web browser running on the user computer and/or might be served by a web server. In various embodiments, the computer system might comprise the web server and/or be in communication with the web server, such that the computer system provides data to the web server to be incorporated in web pages served by the web server for reception and/or display by a browser at the user computer.

For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc. The procedures undertaken to provide a user interface, therefore, can vary depending on the nature of the implementation; in some cases, providing a user interface can comprise displaying the user interface on a display device; in other cases, however, in which the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device. Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies, to name but a few examples.

In many cases, providing a user interface will comprise providing one or more display screens, each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by computer system in accordance with the described embodiments, it should be appreciated that the choice of user interface elements for a particular purpose is typically implementation-dependent and/or discretionary. Hence, the illustrated user interface elements employed by any display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output. Merely by way of example, in a set of embodiments, the user interface allows the user to interact with the system to provide preference data and view identified properties.

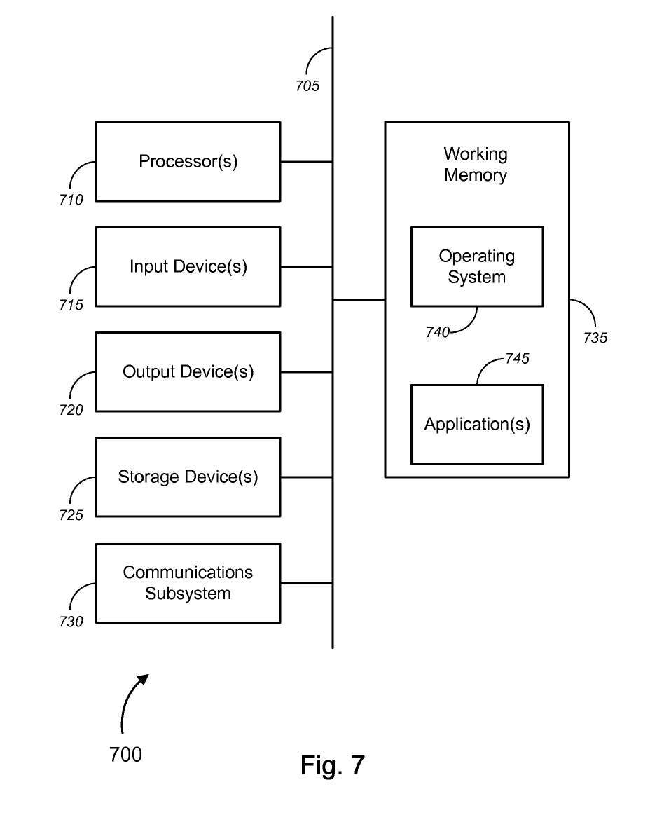

We now turn to FIG. 7, which is a block diagram illustrating an exemplary computer architecture. FIG. 7 provides a schematic illustration of one embodiment of a computer system 700 that can perform the methods provided by various other embodiments, as described herein, and/or can perform the functions of local computer system (e.g., user devices associated with one or more users 105 and/or with one or more friends 160), or remote computer system 115, 120, 140, or 150, or other computer systems as described above. It should be noted that FIG. 7 is meant only to provide a generalized illustration of various components, of which one or more, or none, of each may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705, or may otherwise be in communication, as appropriate. The hardware elements may include one or more processors 710, including without limitation one or more general-purpose processors, or one or more special-purpose processors such as digital signal processing chips, graphics acceleration processors, and/or the like; one or more input devices 715, which can include, without limitation, a mouse, a keyboard, or the like; and one or more output devices 720, which can include, without limitation, a display device, a printer, and/or the like.

The computer system 700 may further include, or be in communication with, one or more storage devices 725. The one or more storage devices 725 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, and/or the like. Such storage devices may be configured to implement any appropriate data stores, including, without limitation, various file systems, database structures, and/or the like.

The computer system 700 might also include a communications subsystem 730, which can include without limitation a modem, a network card (wireless or wired), an infra-red communication device, a wireless communication device or chipset, and/or the like. The wireless communication device might include, but is not limited to, a Bluetooth™ device, an 802.11 device, a WiFi device, a WiMax device, a WWAN device, cellular communication facilities, and/or the like.

The communications subsystem 730 may permit data to be exchanged with a network (such as network 110 or 135, to name examples), with other computer systems, with any other devices described herein, or with any combination of network, systems, and devices. According to some embodiments, network 110 (as well as network 135) might include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 700 will further comprise a working memory 735, which can include a RAM or ROM device, as described above.

The computer system 700 may also comprise software elements, shown as being currently located within the working memory 735, including an operating system 740, device drivers, executable libraries, or other code. The software elements may include one or more application programs 745, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 725 described above. In some cases, the storage medium might be incorporated within a computer system, such as the system 700. In other embodiments, the storage medium might be separate from a computer system—that is, a removable medium, such as a compact disc, and/or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 700, or might take the form of source or installable code. The source or installable code, upon compilation, installation, or both compilation and installation, on the computer system 700 might take the form of executable code. Compilation or installation might be performed using any of a variety of generally available compilers, installation programs, compression/decompression utilities, and/or the like.

It will be apparent to those skilled in the art that substantial variations may be made in accordance with specific requirements. For example, customized hardware—such as programmable logic controllers, field-programmable gate arrays, application-specific integrated circuits, and/or the like—might also be used. In some cases, particular elements might be implemented in hardware, software (including portable software, such as applets, etc.), or both. Further, connection to other computing devices such as network input/output devices may be employed. Such network input/output devices may be used to send and receive input and output to and from remote computer systems, which may effectively implement part or all of the relevant computing tasks for which the system 700 is responsible.

As mentioned above, in one aspect, some embodiments may employ a computer system, such as the computer system 700, to perform methods in accordance with various embodiments of the invention. According to a set of embodiments, some or all of the procedures of such methods might be performed by the computer system 700 in response to processor 710 executing one or more sequences of one or more instructions. The one or more instructions might be incorporated into the operating system 740 or other code that may be contained in the working memory 735, such as an application program 745. Such instructions may be read into the working memory 735 from another computer readable medium, such as one or more of the storage devices 725. Merely by way of example, execution of the sequences of instructions contained in the working memory 735 might cause the one or more processors 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 700, various computer readable media might be involved in providing instructions or code to the one or more processors 710 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and/or transmission media. Non-volatile media includes, for example, optical disks, magnetic disks, or both, such as the storage devices 725. Volatile media includes, without limitation, dynamic memory, such as the working memory 735. Transmission media includes, without limitation, coaxial cables, copper wire and fiber optics, including the wires that comprise the bus 705, as well as the various components of the communication subsystem 730, or the media by which the communications subsystem 730 provides communication with other devices. Hence, transmission media can also take the form of waves, including without limitation radio, acoustic, or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

Various forms of computer readable media may be involved in carrying one or more sequences of one or more instructions to the processor(s) 710 for execution. Merely by way of example, the instructions may initially be carried on a magnetic disk or optical disc of a remote computer. A remote computer might load the instructions into its dynamic memory and send the instructions as signals over a transmission medium to be received or executed by the computer system 700. These signals, which might be in the form of electromagnetic signals, acoustic signals, optical signals, or the like, are all examples of carrier waves on which instructions can be encoded, in accordance with various embodiments of the invention.

The communications subsystem 730, or components thereof, generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

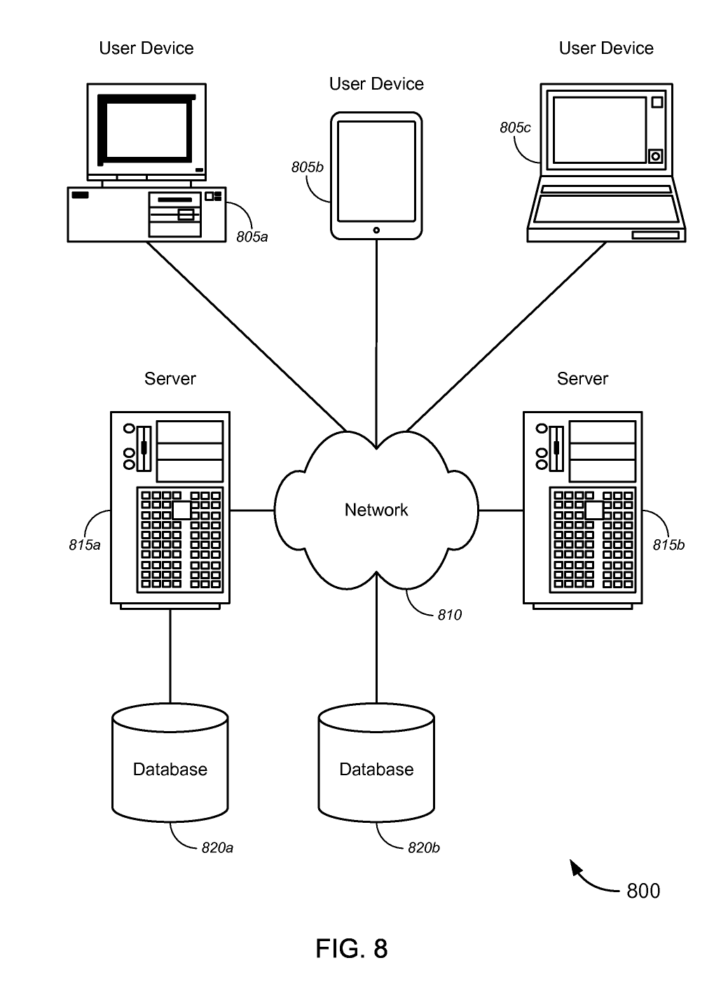

As noted above, a set of embodiments comprises methods and systems for determining suitability and/or desirability of a prospective residence for a user, determining the suitability of a prospective residence for a prospective home buyer or renter, generating or updating user profiles or user preference profiles that may applied specifically to home search purposes and/or generally to non-home-related purposes, and/or the like. FIG. 8 illustrates a schematic diagram of a system 800 that can be used in accordance with one set of embodiments. The system 800 can include one or more user computers or user devices 805. A user computer or user device 805 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 805 can also have any of a variety of applications, including one or more applications configured to perform methods provided by various embodiments (as described above, for example), as well as one or more office applications, database client and/or server applications, and/or web browser applications. Alternatively, a user computer or user device 805 can be any other electronic device, such as a thin-client computer, Internet-enabled mobile telephone, and/or personal digital assistant, capable of communicating via a network (e.g., the network 810 described below) and/or of displaying and navigating web pages or other types of electronic documents. Although the exemplary system 800 is shown with three user computers or user devices 805, any number of user computers or user devices can be supported.

Certain embodiments operate in a networked environment, which can include a network 810. The network 810 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network 810 can include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 815. Each of the server computers 815 may be configured with an operating system, including without limitation any of those discussed above, as well as any commercially (or freely) available server operating systems. Each of the servers 815 may also be running one or more applications, which can be configured to provide services to one or more clients 805 and/or other servers 815. Such applications can include, without limitation, applications configured to perform the methods described above and/or illustrated by FIGS. 2-6. An example of a server 815 can be a computer system 700 described with respect to FIG. 7, above.

Merely by way of example, one of the servers 815 might be a data server, as described above. The data server might include (or be in communication with) a web server, which can be used, merely by way of example, to process requests for web pages or other electronic documents from user computers 805. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform methods of the invention.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™, or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer or user device 805 and/or another server 815. In some embodiments, an application server can create web pages dynamically for displaying the information in accordance with various embodiments, such as web pages for collecting user preference data and/or for displaying prospective residences identified using the methods disclosed herein, or can perform one or more of the processes for determining suitability and/or desirability of a prospective residence for a user, or the like, as described in detail above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer or user device 805 and/or server 815.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820. The location of the database(s) 820 is discretionary: merely by way of example, a database 820a might reside on a storage medium local to (and/or resident in) a server 815a (and/or a user computer or user device 805). Alternatively, a database 820b can be remote from any or all of the computers 805, 815, so long as it can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computer and from a database, a list of real estate listings, each listing pertaining to an available home and comprising a plurality of attributes about the available home;
collecting, with the computer, information about a plurality of factors relating to a prospective homeseeker;
generating, with the computer, a homeseeker profile for the prospective homeseeker, based at least in part on the plurality of factors, the homeseeker profile comprising a prioritized list of homeseeker criteria;
inferring, with the computer and from the prioritized list of homeseeker criteria, a prioritized list of real estate listing characteristics to satisfy the homeseeker;
generating, with the computer, a list of potential homes from the list of real estate listings, based on comparisons between the prioritized list of real estate listing characteristics and attributes of at least some of the real estate listings;
prioritizing, with the computer, the list of potential homes, based at least in part on matches between attributes of the potential homes and the prioritized list of real estate listing characteristics; and
displaying, for the prospective homeseeker, the prioritized list of potential homes.

2. The method of claim 1, wherein the list of real estate listings is a list of properties available for lease, and wherein the homeseeker is interested in leasing a home.

3. The method of claim 1, wherein the list of real estate listings is a list of properties for sale, and wherein the homeseeker is interested in purchasing a home.

4. The method of claim 1, wherein generating the list of potential homes comprises generating a composite score for each of the potential homes, the composite score being a weighted score derived from a plurality of the homeseeker criteria.

5. The method of claim 4, further comprising:
adjusting relative weights of one or more of the plurality of homeseeker criteria, using a learning algorithm, to enhance prospective homeseeker satisfaction with the displayed list of potential homes.

6. The method of claim 1, wherein one of the plurality of factors is a location of a likely frequent destination of the prospective homeseeker.

7. The method of claim 1, wherein one of the plurality of factors is a history of prior residences of the prospective homeseeker.

8. The method of claim 1, wherein one or more of the plurality of factors includes information obtained from a social networking account of the potential homeseeker.

9. The method of claim 1, wherein one or more of the plurality of factors includes information indicative of user preferences of the homeseeker across a multiplicity of dimensions comprising home-related dimensions and non-home-related dimensions.

10. The method of claim 1, wherein one or more of the plurality of factors includes information about locations of a plurality of associates of the homeseeker.

11. The method of claim 10, further comprising identifying, with the computer, the plurality of associates of the homeseeker.

12. The method of claim 11, wherein identifying the plurality of associates of the homeseeker comprises identifying individuals associated with the homeseeker on one or more social networks.

13. The method of claim 1, wherein one of the plurality of attributes of each available home is an estimated total monthly cost of the available home.

14. The method of claim 1, wherein one of the plurality of attributes of each available home is an estimated total cost of ownership of the available home.

15. The method of claim 1, wherein generating the homeseeker profile comprises analyzing at least one of a psychographic relationship or a behavioral relationship between one or more of the plurality of factors and one or more of the homeseeker criteria.

16. The method of claim 1, wherein generating the homeseeker profile comprises generating the homeseeker profile using at least in part data from at least one of a demographic segment or a behavioral segment of a population group known to match at least some known characteristics of the homeseeker.

17. The method of claim 1, wherein generating the homeseeker profile comprises estimating demand for one or more features of available homes based on aggregate behavior of a plurality of homeseekers other than the prospective homeseeker.

18. The method of claim 17, wherein the prospective homeseeker has a relationship with each of the plurality of homeseekers other than the prospective homeseeker.

19. The method of claim 1, wherein generating the homeseeker profile comprises collecting information about a plurality of factors relating to each of a plurality of individuals within a single household.

20. The method of claim 19, wherein collecting information about a plurality of factors comprises collecting, from one or more of the plurality of individuals within the single household, self-reported personal data about one or more individuals of the plurality of individuals within the single household.

21. The method of claim 19, wherein collecting information about a plurality of factors comprises collecting, from one or more of business, social media sources, or other on-line sources, information indicative of personal preferences and demographic information about one or more individuals of the plurality of individuals within the single household, as a result of one or more of business activities, social media activities, or other on-line activities of the one or more individuals within the household.

22. The method of claim 1, further comprising customizing a display of the list of potential homes, based at least in part on the prioritized list of homeseeker criteria.

23. The method of claim 22, wherein customizing a display of the list of potential homes comprises emphasizing features of each potential home that correspond to high-priority homeseeker criteria.

24. The method of claim 22, wherein customizing a display of the list of potential homes comprises one of de-emphasizing or eliminating features of each potential home that correspond to homeseeker criteria that are indicated as being one of unimportant or adverse to interests of the prospective homeseeker.

25. An apparatus, comprising:
a non-transitory computer readable medium having encoded thereon a set of instructions executable by one or more computers to perform one or more operations, the set of instructions comprising:
instructions to receive, from a database, a list of real estate listings, each listing pertaining to an available home and comprising a plurality of attributes about the available home;
instructions to collect information about a plurality of factors relating to a prospective homeseeker;
instructions to generate a homeseeker profile for the prospective homeseeker, based at least in part on the plurality of factors, the homeseeker profile comprising a prioritized list of homeseeker criteria;
instructions to infer, from the prioritized list of homeseeker criteria, a prioritized list of real estate listing characteristics to satisfy the homeseeker;
instructions to generate a list of potential homes from the list of real estate listings, based on comparisons between the prioritized list of real estate listing characteristics and attributes of at least some of the real estate listings;
instructions to prioritize a list of potential homes, based at least in part on matches between attributes of the potential homes and the prioritized list of real estate listing characteristics; and
instructions to display the prioritized list of potential homes.

26. A computer system, comprising:
one or more processors; and
a computer readable medium in communication with the one or more processors, the computer readable medium having encoded thereon a set of instructions executable by the computer system to perform one or more operations, the set of instructions comprising:
instructions to receive, from a database, a list of real estate listings, each listing pertaining to an available home and comprising a plurality of attributes about the available home;
instructions to collect information about a plurality of factors relating to a prospective homeseeker;
instructions to generate a homeseeker profile for the prospective homeseeker, based at least in part on the plurality of factors, the homeseeker profile comprising a prioritized list of homeseeker criteria;
instructions to infer, from the prioritized list of homeseeker criteria, a prioritized list of real estate listing characteristics to satisfy the homeseeker;
instructions to generate a list of potential homes from the list of real estate listings, based on comparisons between the prioritized list of real estate listing characteristics and attributes of at least some of the real estate listings;
instructions to prioritize a list of potential homes, based at least in part on matches between attributes of the potential homes and the prioritized list of real estate listing characteristics; and
instructions to display the prioritized list of potential homes.
